(19) United States
(12) Patent Application Publication
(10) Pub. No.: US 2026/0042086 A1
(43) Pub. Date: Feb. 12, 2026

(54) Pt-Doped Ru Nanoparticles Anchored on 'Black Gold' for Enhanced Hydrogenations/Reductions Including Semi-Hydrogenation Reactions

(71) Applicant: Tata Institute of Fundamental Research, Mumbai (IN)

(72) Inventors: Vivek Polshettiwar, Mumbai (IN); Gunjan Sharma, Mumbai (IN)

(21) Appl. No.: 19/033,165

(22) Filed: Jan. 21, 2025

(30) Foreign Application Priority Data
Aug. 8, 2024 (IN) 202421060074

(51) Int. Cl. B01J 23/52; B01D 61/14; B01D 69/02; B01J 23/46; B01J 35/39; B01J 35/45; B01J 35/61; B01J 35/63; B01J 37/00; B01J 37/02; B01J 37/04; B01J 37/06; B01J 37/10; B01J 37/34

(52) U.S. Cl. CPC B01J 23/52; B01D 61/145; B01D 69/02; B01J 23/462; B01J 35/39; B01J 35/45; B01J 35/615; B01J 35/633; B01J 37/009; B01J 37/0205; B01J 37/0211; B01J 37/04; B01J 37/06; B01J 37/10; B01J 37/343; B01D 2325/34

(57) ABSTRACT

A hybrid catalytic nanoreactor having selectivity and stability in presence of air is provided for reduction reactions including semi-hydrogenations comprising of light harvesting dendritic plasmonic colloidosomes (DPC) of gold preferably as black gold and co-acting synergistically active catalytic sites of Pt-doped Ru bimetallic nanoparticles for desired significantly special selectivity and air-stability as a plasmonic reduction catalyst favoring plasmon-mediated simultaneous reduction and oxidation of metal active sites for facilitating reduction reactions including semi-hydrogenation activity. Said black gold/RuPt catalyst showcases good efficiency in acetylene semi-hydrogenation, attaining over 90% selectivity with ethene production rate of 320 mmol g⁻¹ h⁻¹ with its stability evident from 100 h of operation with continuous air flow, attributed to the synergy of co-existing metal oxide and metal phases. The catalyst's stability is further enhanced by plasmon-mediated concurrent reduction and oxidation of the active sites, facilitating its end use and applications in chemical industries, petrochemical industries, and applications catalysis.

### CROSS REFERENCE TO RELATED APPLICATIONS

This application is a non-provisional application of and claims priority to Indian Convention patent application No. 202421060074 filed on Aug. 8, 2024. The entire disclosure of the patent application is part of the disclosure of the present application and are hereby incorporated by reference in their entireties.

### FIELD OF THE INVENTION

The present invention provides for hybrid catalytic nanoreactor having selectivity and stability in presence of air for reduction reactions including semi-hydrogenations comprising of light harvesting dendritic plasmonic colloidosomes (DPC) of gold and co-acting synergistically active catalytic sites of Pt-doped Ru bimetallic nanoparticles for desired significantly special selectivity and air-stability as a plasmonic reduction catalyst favouring plasmon-mediated simultaneous reduction and oxidation of metal active sites for facilitating reduction reactions including semi-hydrogenation activity.

More particularly, said plasmonic reduction catalyst is stable only in the presence of air, is achieved by integrating Pt-doped Ru nanoparticles on black gold. This black gold/RuPt catalyst showcases good efficiency in acetylene semi-hydrogenation, attaining over 90% selectivity with an ethene production rate of 320 mmol g⁻¹ h⁻¹. Its stability, evident in 100 h of operation with continuous air flow, is attributed to the synergy of co-existing metal oxide and metal phases. The catalyst's stability is further enhanced by plasmon-mediated concurrent reduction and oxidation of the active sites, facilitating its end use and applications in chemical industries, petrochemical industries, and applications catalysis.

### BACKGROUND ART

The creation of light-harvesting and catalytic nanoreactors can be facilitated by the use of nanochemistry techniques, which offer strong tools for going beyond the limitations of conventional materials. It has been demonstrated before that photoexcitation of Ag, Au, and Cu plasmonic metal nanoparticles can trigger direct photochemical reactions, but the poor chemical reactivity of noble metal surfaces limits their direct application in catalysis.³ Therefore, designing functional nanostructures in which a plasmonic material concentrates light energy and efficiently directs this energy to a more active catalytic material is of interest. Successful design and synthesis of these ‘hybrid plasmonics’ can pave new ways for carrying out various catalytic transformations with better activities and selectivities by providing alternative reaction pathways along with the more efficient use of solar light as a sustainable energy source.

A challenging reaction in these aspects is acetylene semi-hydrogenation in excess ethylene. One of the fundamental building blocks used to make plastic and important chemicals is ethylene, which is majorly produced by steam cracking of hydrocarbons along with a small amount of co-produced acetylene. The coexisting acetylene must be reduced to an acceptable level (<5 ppm) because it can severely poison the downstream catalyst for ethylene transformation. Owing to the petrochemical industry's interest in the reaction, various catalysts have been explored to eliminate the acetylene impurity, many of which focus on ‘active site isolation concept’ by forming either a Pd based intermetallic/alloy (Pd—Ag/Al₂O₃ is commercially employed) or selectively poisoning Pd sites (Lindlar's catalyst) to tune the adsorption of ethylene which are, nevertheless, often at the cost of activity loss due to the presence of substantial inaccessible Pd sites. Single-atom catalysts (SACs) have recently attracted a lot of attention due to their high activity and selectivity in a wide range of reactions.

Drawbacks Connected with Hitherto Known Catalysts

Despite their great activity and selectivity, SACs' hydrogenation activity and long-term stability under realistic reaction conditions is yet to be enhanced. Quite recently electrocatalysis has gained a lot of interest as a green chemistry approach but it is faced by its fair share of unaddressed issues like large scale application and low cell energy efficiency. Thermocatalysis is thus believed to be the most efficient and has been employed in industry for decades. However, to achieve a significant conversion value, a relatively high reaction temperature (>100° C.) is required, which potentially leads to a safety concern in the reactor beds. The search for a novel catalyst offering high selectivity at full conversion is still ongoing. Surprisingly, the reports on photocatalytic acetylene semi-hydrogenation are scarce, despite the fact that it has been shown to be a promising method for enhancing the activity and selectivity of numerous important reactions like CO₂ hydrogenation, Reverse Water Gas Shift Reaction, and Fischer Tropsch Synthesis.

### OBJECTS OF THE INVENTION

It is thus the basic object of the present invention to provide for hybrid catalytic nanoreactor as air stable reduction catalysts that would efficiently enable reduction reactions including acetylene semi-hydrogenation.

It is another aspect of the present invention to provide for said air stable reduction catalysts as highly active, selective, and notably air-stable plasmonic reduction catalyst specifically for acetylene semi-hydrogenation that would be able to outperform all known catalysts.

It is still another object of the present invention to provide for said reduction catalyst that would show the presence of co-existing metal oxide and metal phases to not only evidence high catalytic activity but would also support its long-term air stability.

It is yet another object of the present invention to provide for said reduction catalysts that would be able to activate the reacting molecules based on both thermal and non-thermal pathways.

It is another object of the present invention to provide for said reduction catalyst as plasmonic reduction catalyst that would be surprisingly stable in the presence of air as select co-operative nanoparticle loaded ‘dendritic plasmonic colloidosomes (DPC)’, also known as black gold.

It is yet another object of the present invention to provide for said select cooperative nanoparticles loaded Pt-doped Ru nanoparticles loaded ‘dendritic plasmonic colloidosomes (DPC)’ and a process of preparation thereof.

### SUMMARY OF THE INVENTION

It is thus the basic aspect of the present invention to provide for a hybrid catalytic nanoreactor having selectivity and stability in presence of air for reduction reactions including semi-hydrogenations comprising of light harvesting dendritic plasmonic colloidosomes (DPC) of gold and co-acting synergistically active catalytic sites of Pt-doped Ru bimetallic nanoparticles for desired significantly special selectivity and air-stability as a plasmonic reduction catalyst favoring plasmon-mediated simultaneous reduction and oxidation of metal active sites for facilitating reduction reactions including semi-hydrogenation activity.

Preferably said hybrid catalytic nanoreactor is provided wherein said Pt-doped Ru bimetallic nanoparticles as Pt doped/alloyed Ru nanoparticulate clusters have Ru:Pt ratio of 90:10 impregnated on DPC of gold as black gold having Au deposited Dendritic Fibrous Nano Silica (DFNS) based DPC/RuPt catalyst, wherein said Pt of the bimetallic nanoparticles selective for H₂ dissociation and Ru for controlling the extent of hydrogenation provide for synergistic co-operativity between Ru and Pt to enable selective acetylene semi-hydrogenation reaction with good ethene productivity and selectivity giving acetylene conversion of ˜97% while maintaining ˜90% selectivity.

According to another preferred aspect of the present invention there is provided said hybrid catalytic nanoreactor wherein said nanoreactor is exceptionally air stable for at least 100 hours under continuous flow of air alongside reactant feed towards catalytic reduction based on provided co-existing metal oxide and metal phases under plasmon-mediated simultaneous reduction and oxidation of the active site during reactions with oxide active sites getting continuously generated under air flow with the reactant feed enabling high catalytic reduction activity and said long-term stability for at least 100 h with said catalytic reduction activity dropping by ˜20% of its initial value in 100 h in the absence of airflow that is recoverable by high-temperature air treatment.

Preferably said hybrid catalytic nanoreactor is provided wherein said nanoreactor of DPC/RuPt catalyst includes RuPt NPs of ˜1.5 nm deposited on Au nanospheres ˜10 nm with a separation of ˜3 nm shows high catalytic activity based on activating chemical bonds by inducing polarization in their vicinity enabling 5-fold enhancement of electric field as compared to pristine DPC due to near-field coupling between the RuPt nanoparticles with DPC, which electric field is predominantly concentrated around the RuPt sites within the gaps of Au nanoparticles, said nanoreactor with high catalytic activity is also enabled by simultaneous effects of reactor temperature and light intensity to thereby achieve the following:
a. acetylene semi-hydrogenation/reduction with over 85-90% selectivity and productivity of 320 mmol g⁻¹ h⁻¹ of selective ethene outperforming previous all reports by more than double at comparatively lower H₂:C₂H₂ ratio (5:1) and low catalyst bed temperature (Tₛ) of 130° C. and reactor temperature (T_{R}) of 75° C.;
b. highest productivity at a total gas flow of 110 mL min⁻¹ giving moderate acetylene conversion of 20% at high Gas Hourly Space Velocity (GHSV) of 1320000 mL g⁻¹ h⁻¹ entailing said total gas flow of 110 mL min-1, and lower gas flow rate of 9 mL min⁻¹ and higher photo illumination intensity of 3.5 W cm-2 giving acetylene conversion of ˜97% while maintaining ˜90% selectivity and ethene productivity of 31 mmol g⁻¹ h⁻¹;
c. productivity of ˜300 mmol g⁻¹ h⁻¹ achieved at Tₛ of 200° C. in the dark by external heating, comparable to what was achieved with photo illumination intensity of 3 W cm⁻² (Ts=137° C.) indicating both thermal and non-thermal/photothermal effects thereby unveiling the possibility of lowering the activation energy barrier due to said plasmonic catalysis.
d. productivity that is comparable at different photo illumination wavelengths owing to the broadband absorption of black gold also at different designated Ts values.

According to yet another preferred aspect of the present invention there is provided said hybrid catalytic nanoreactor wherein said Pt-doped Ru nanoparticulate clusters impregnated on DPC of gold as DPC/RuPt catalyst have ˜1.78 wt. % Ru and 0.29 wt. % Pt with the total metal content being 2.07 wt. %.

Preferably said hybrid catalytic nanoreactor is provided wherein said Pt-doped Ru nanoparticulate clusters loaded on DPC of gold as DPC/RuPt catalyst is a calcined Polyvinylpyrrolidone impregnated (PVP)-stabilized RuPt clusters loaded on said DPC in select loadings of 3-20 wt. % that is preferably 10 wt. % RuPt cluster loaded having Brunauer-Emmett-Teller (BET) surface area of ˜415 m² g⁻¹ with a pore volume of 0.45 m³ g⁻¹ vs. as prepared DPC/RuPt catalyst having surface area of 355 m² g⁻¹ with a pore volume of 0.34 cm³ g⁻¹, with said wt. % range of loadings having elemental compositions as per the following:

| Sample | Si (wt %) | O (wt %) | Au (wt %) | Ru (wt %) | Pt (wt %) |
|---|---|---|---|---|---|
| DPC/RuPt-3-Calc | 41.5 ± 7.0 | 16.9 ± 3.0 | 36.8 ± 10.1 | 4.7 ± 1.4 | — |
| DPC/RuPt-5-Calc | 49.1 ± 11.6 | 15.6 ± 3.2 | 29.1 ± 11.9 | 6.0 ± 2.8 | — |
| DPC/RuPt-10-Calc | 59.9 ± 10.6 | 12.5 ± 3.3 | 16.9 ± 7.6 | 10.5 ± 4.1 | 0.2 ± 0.4 |
| DPC/RuPt-20-Calc | 50.1 ± 9.3 | 11.0 ± 2.1 | 19.4 ± 6.6 | 18.3 ± 3.3 | 1.07 0.8 |

According to yet another preferred aspect of the present invention there is provided said nanoparticles as Pt doped/alloyed Ru nanoparticulate clusters impregnated on DPC of gold as black gold having cycle-by-cycle Au deposited onto said Dendritic Fibrous Nano Silica (DFNS) and is preferably 4^{th} cycle Au deposited DPC impregnated with Pt doped/alloyed Ru nanoparticulate clusters.

According to another aspect of the present invention there is provided a process for the synthesis of hybrid catalytic nanoreactor comprising the steps of
(i) providing said light harvesting dendritic plasmonic colloidosomes (DPC) as black gold including Au deposited onto Dendritic Fibrous Nano Silica (DFNS);
(ii) providing synergistically active catalytic site generating Pt-doped Ru nanoparticles as Ru/Pt nanoparticulate clusters;
(iii) Impregnating said Ru/Pt nanoparticulate clusters on said dendritic plasmonic colloidosomes (DPC) of gold and obtaining therefrom said hybrid nanoreactor based DPC/RuPt catalyst including light harvesting dendritic plasmonic colloidosomes (DPC) of gold and co-acting synergistically active catalytic sites.

Preferably in said process wherein said step of (i) of providing dendritic plasmonic colloidosomes (DPC) as black gold is preferably synthesized based on cycle-by-cycle approach includes the following sub steps:

Refluxing (Dendritic Fibrous Nanosilica) DFNS (4 g) with APTES ((3-Aminopropyl)triethoxysilane) (4 mL, 17 mmol) in 250 mL of toluene at 80° C. for 24 h allowing functionalization of DFNS with APTES that was then washed with toluene, ethanol and then dried in an oven for ten hours at 80° C. to yield DFNS-APTS, followed by
dispersing said DENS-APTS (500 mg) in water (50 mL) by a sonicator for 15 minutes and stirred for an additional 10 minutes at room temperature to which reaction mixture from a gold-stock solution containing 100 mg mL-1 of gold (III) chloride trihydrate salt, 43 mg was added dropwise;
sonicating the above reaction mixture for 15 minutes, followed by stirring for 2 hours at room temperature and thereafter adding freshly prepared NaBH₄ solution (5 mL, 1 M in water) that was then stirred again for two hours at room temperature followed to which the solid was isolated using centrifugation at 10,000 rpm for 10 minutes, followed by three washings with 30 mL each of water and ethanol with the resultant solid dried at 80° C. in an oven for 2 h and was named DPC-CO, 0^{th} cycle;
dispersing DPC-CO (500 mg) in 1000 mL of prepared K-gold solution by dissolving 300 mg of HAuCl₄·3H₂O and 2800 mg of K₂CO₃ in 2 L of DI water to attain C1 growth cycle whereby the solution was sonicated for 10 seconds and then stirred at room temperature for 10 minutes (200 rpm) followed by the addition of 5 mL of ammonium hydroxide (25%) and subsequent stirring for 15 minutes followed to which Formaldehyde solution (90 mL, 37 wt % in H₂O) was added, and stirred for 24 hours at room temperature providing for solid that was isolated by centrifugation at 10,000 rpm for 10 minutes and washed three times with water (100 mL each time) and ethanol (100 mL each time) to yield DPC-C1 as base material;
repeating the cycle as above with DPC-C1 as base material to obtain DPC-Cx with 2, 3, and 4 growth cycles leading to the resultant solid obtained after 4^{th} cycle of DPC-C4 denoted as “black gold” and used as the plasmonic support over which RuPt nanoparticles (NPs) were loaded.

According to another preferred aspect of the process wherein said step (ii) of providing Pt-doped Ru nanoparticles as Ru/Pt nanoparticulate clusters is preferably based on ethylene glycol (EG) reduction process and includes the following sub-steps

Dissolving H₂PtCl₆ and RuCl₃·nH₂O by maintaining Ru:Pt atomic ratio set at 90:10 and PVP (20 equivalence to Ru in monomer units of PVP) in ethylene glycol (EG) (10 mL/mmol_{PVP}) and the reaction mixture stirred at 80° C. under Ar flow for 1 h followed to which the mixture was heated to 180° C. and stirred for 1 hour in an Ar environment when the solution turned dark brown followed by cooling the suspension to room temperature under stirring to which water was added to reduce viscosity with the thus attained colloidal metal clustersdeionized three times by ultrafiltration using a membrane filter with a cut-off molecular weight of 10 kDa before being collected as a powder by lyophilization yielding PVP stabilized Ru/Pt clusters.

More preferably in said process said step (iii) of impregnating said Ru/Pt nanoparticulate clusters on said dendritic plasmonic colloidosomes (DPC) of gold as DPC/RuPt includes the following sub-steps:

dispersing 75 mg of PVP stabilized RuPt bimetallic NPs with effective metal content˜2% in 15 mL ethanol in 250 mL RB flask and sonicating for 90 min followed to which Black Gold (DPC-C4, 15 mg) was then added to this dispersion and again sonicated for 30 s that was thereafter stirred at 60° C. under ambient conditions for 1 h and dried under vacuum at 80° C. for 2 h to yield the resultant powder (DPC/RuPt-10, ASP—as prepared with 10 wt. % loading of RuPt over black gold followed to which the same was calcined in a muffle furnace at 800° C. (10° C./min ramp) for 2 h to oxidize the as-prepared sample to DPC/RuPt-10-Calcined to obtain hybrid nanoreactor based DPC/RuPt catalyst as oxidized PVP free catalyst.

According to yet another aspect of the present invention there is provided a photocatalytic hydrogenation system based on flow reactors for hydrogenation and semi-hydrogenation reactions by the hybrid catalytic nanoreactor comprising:
gas inlet (I) and outlet (O) to reactor chamber (RC) including air flow therein;
reactor chamber (RC) with a quartz window (QW) in operative connection for visible light illumination and for supporting porous ceramic including Al₂O₃crucible accommodating hydrogenation/semi-hydrogenation catalyst, a heater (H) for heating and thermocouples including external and internal-in-built thermocouples to precisely measure catalyst bed (Ts) and reactor (T_{R}) temperatures respectively that are controllable by temperature controllers;
said inlet connected to mass flow controllers (MFCs) including air flow control means with the outlet connected to a gas chromatographic unit having a column and a thermal conductivity detector (TCD).

Preferably in said photocatalytic hydrogenation system said visible light illumination by light source from the top of reactor chamber (RC) through said quartz window (QW) is focused into the reactor by plurality of lens (L) and mirror (M) based assembly wherein light from said light source including Xe lamp source changes its path perpendicularly to be focused into the reactor through selectively positioned biconvex lenses flanked by said plane mirror (M) for desired focusing.

More preferably a process for photocatalysis based on the photocatalytic hydrogenation system is provided comprising the steps of:
taking the DPC/RuPt catalyst (5 mg) in a ceramic porous base crucible and placing inside the reactor chamber,
flowing Argon (Ar) gas (150 mL min-1) through the reactor for 10 minutes,
introducing the reactant gases into the reactor chamber through mass flow controllers; C₂H₂ (10% in Ar) at 30 mL min⁻¹, H₂ at 15 mL min⁻¹, C₂H₄ (60 mL min-1) for competitive reactions and Ar (55 mL min⁻¹) for non-competitive reaction along with air (5 mL min⁻¹) constituting a total flow of 110 mL min⁻¹ (for competitive) and 105 mL min⁻¹ (for non-competitive) at 1 bar pressure,
or, introducing into reactor at 1 bar pressure a total flow of 100 mL min⁻¹ of C₂H₂/H₂/Ar=1/5/94 mL min⁻¹;
heating and/or irradiating the catalyst with light (300 W Xenon Lamp ˜2.7 W cm⁻², spanning wave lengths of 400-1100 nm) and monitoring the progress of the reaction inline by calibrated GC connected at the outlet every 4 minutes including
monitoring for thermal and photothermal activation of ingredients towards higher temperature reaction in the dark by providing external heating to the catalyst bed by the heater inside the reaction chamber, monitoring reactions under different irradiated light intensities and wavelength by changing the light intensity of Xe lamp or by changing wavelength of diode lasers keeping the intensity fixed;
wherein calibrating said GC by gases including H₂, O₂, N₂, CO₂, CH₄, C₂H₄, C₂H₆, C₂H₂, and higher hydrocarbons including C₄ is prior done for analysing the outlet gaseous products based on slope of peak area vs. ppm plot giving the calibration constant (area/ppm) used to preferably calculate ethene product formation rate and selectivity of such products formed.

Preferably in said process of photocatalysis for competitive acetylene semi-hydrogenation by said catalyst, the same is carried out in a flow reactor at 1 bar pressure with a total flow of 100 mL min⁻¹ (C₂H₂/H₂/Ar=1/5/94 mL min⁻¹), under illumination of visible light from a Xenon lamp spanning 400-1100 nm at 2.7 W cm⁻² favoring attainment of ethene production rate of 320 mmol g⁻¹ h⁻¹ with a (Gas Hourly Space Velocity) GHSV of 1320000 mL g⁻¹ h⁻¹.

### BRIEF DESCRIPTION OF FIGURES

FIG. 1 illustrates acetylene semi-hydrogenation in the presence of excess ethene using DPC/RuPt-10-Calc. a) at different H₂:C₂H₂ ratios with visible light illumination (2.7 W cm⁻² light intensity, 1 bar pressure, 3% acetylene in feed, C₂H₄:C₂H₂=20:1, air flow-5 mL min⁻¹ and 1320000 mL g⁻¹ h⁻¹ GHSV); b) Effect of GHSV (using 5:1 H₂:C₂H₂ ratio and 3% acetylene in feed, air flow-5 mL min⁻¹, 2.7 W cm⁻²); c) Ethene and ethane productivity with the catalyst bed temperature reached at different light intensities (using optimized flow conditions-5:1 H₂:C₂H₂ ratio and 3% acetylene in feed, C₂H₄:C₂H₂=20:1, air flow-5 mL min⁻¹ and 1320000 mL g⁻¹ h⁻¹ GHSV); d) The effect of temperature on acetylene semi-hydrogenation over DPC/RuPt-10-Calc catalyst in dark at optimized flow conditions; e) Effect of wavelength of light on acetylene semi-hydrogenation and corresponding catalyst bed temperatures (using optimized flow conditions at 2.7 W cm⁻²); f) Comparison of different air calcined catalysts at optimized reaction conditions and similar individual metal loadings; g) Long-term stability of DPC/RuPt-10-Calc catalyst for competitive acetylene semi-hydrogenation, with 400-1100 nm illumination at 2.7 W cm⁻², 1 bar pressure, optimized flow conditions:C₂H₂/C₂H₄/H₂/Ar/Air-3/60/15/27/5; h) Effect of air flow on the stability of the catalyst in high conversion regime (Flow-C₂H₂/C₂H₄/H₂/Ar/Air-0.2/4/1/1.8/0.5 at 2.7 W cm⁻², 400-1100 nm).

FIG. 2 illustrates characterization and physicochemical properties of the DPC/RuPt-10-Calc catalyst. a-b) HRTEM images; c) UV-vis absorption spectra; d) HAADF STEM image; e-i) EDS elemental maps; j) PXRD patterns for DPC/RuPt-10-ASP and DPC/RuPt-10-Calc; k) XPS spectrum for Ru 3d and C Is showing different oxides of Ru present in DPC/RuPt-10-Calc; 1) XPS spectrum for Pt 4f showing oxidation states of Pt in DPC/RuPt-10-Calc; m) N₂ sorption isotherms for DPC, DPC/RuPt-10-ASP and DPC/RuPt-10-Calc.

FIG. 3 illustrates comparison of the best reported thermal and photo-thermal catalytic systems employed for semi-hydrogenation in excess ethene (detailed comparison is provided in Table S4).

FIG. 4 illustrates thermal and non-thermal activation mechanism. Electric field enhancement in a) DPC, b) DPC/RuPt, and c) DPC/RuPtOₓ (Source E₀=4509 V m⁻¹ at 2.7 W cm⁻²) using FDTD simulations; d) KIE for acetylene semi-hydrogenation in light (3 W cm⁻²) and in the dark at corresponding catalyst bed temperature; c) Arrhenius plots for activation energy calculation in light and dark at different Ts; f) Acetylene semi-hydrogenation carried out at different light intensities along with external heating, using DPC/RuPt-10-Calc.

FIG. 5 illustrates the role of air in enhancing stability. a) XRD patterns of fresh and spent catalysts with or without flowing air; b) Light-induced reduction of DPC/RuPt-10-Calc.; XPS analysis of spent catalyst, c) with airflow, d) without airflow.

FIG. 6 illustrates in-situ FTIR study of acetylene semi-hydrogenation over DPC/RuPt-10-Calc. a) In-situ DRIFT spectra showing different intermediate formations during acetylene adsorption and hydrogenation driven by light; b) Time-resolved in-situ FTIR spectra of the DPC/RuPt-10-Calc catalyst during C₂H₂ (violet) and subsequent H₂ treatment (orange) at 200° C. in transmission mode; enlarged view of the spectra while undergoing c) C₂H₂ treatment, and d) H₂ treatment.

FIG. 7 illustrates the proposed reaction pathway for acetylene semi-hydrogenation on DPC/RuPt-10-Calc. Formation of various reaction intermediates showing the role of co-existing oxide and reduced species based on in-situ FTIR studies.

Scheme S1 illustrates photocatalytic C₂H₂ semi-hydrogenation experimental set-up. (a) photograph of pike flow reactor (top view) showing the gas inlet, outlet, quartz window, and porous Al₂O₃ crucible containing ˜5 mg catalyst; (b) Zoomed-in version of the pike flow reactor chamber showing the heater and reactor's inbuilt thermocouple for temperature measurement; (c) Measurement of catalyst bed temperature (Ts) using external thermocouple under visible light illumination; (d) A typical photocatalytic reaction setup employed for Ts measurement showing temperature readings (using an external thermocouple, Ts) and reactor's temperature (using reactor's inbuilt thermocouple, T_{R}); (e) focused light path diagram enabled by the lens and mirror assembly; (f) sketch of pike reactor with gas lines and interaction of gas flow with the catalyst powder in the crucible.

Scheme S2 illustrates measurement of surface temperatures using external thermocouple at different light intensities (in W cm⁻²), (a) 0.5. (b) 1, (c) 2, (d) 2.7, (c) 3, (f) 4, (g) 5, (h) 6 with the optimized reactant gas flow-30 mL min⁻¹ C₂H₂ (10% in Ar), 60 mL min⁻¹ C₂H₄, 15 mL min⁻¹ H₂, 5 mL min⁻¹ air at 1 bar pressure.

Scheme S3 illustrates measurement of Tₛ using external thermocouple at different wavelengths of light (a) 808 nm. (b) 637 nm, (c) 447 nm, (d) 405 nm with the optimized reactant gas flow-30 mL min⁻¹ C₂H₂ (10% in Ar), 60 mL min⁻¹ C₂H₄, 15 mL min⁻¹ H₂, 5 mL min⁻¹ air at 1 bar pressure and light intensity of 2.7 W cm⁻².

FIG. S1 illustrates thermogravimetric weight loss profile in Ar flow (40 mL min⁻¹) from 30° C. to 1000° C. showing the loss of capping agent, PVP for (a) Ru clusters, (b) RuPt bimetallic clusters.

FIG. S2 illustrates acetylene semi-hydrogenation over DPC/RuPt-3-Calc (a) ethene and ethane productivity; (b) acetylene conversion and ethene selectivity, with and without airflow along with reactant gas flow of 10 mL min⁻¹ C₂H₂ (10% in Ar), 5 mL min⁻¹ H₂ balanced by Ar to make the total flow 100 mL min⁻¹ at 1 bar pressure and visible light illumination (400-1100 nm) with a light intensity of 2.7 W cm⁻².

FIG. S3 illustrates acetylene semi-hydrogenation over DPC/RuPt-3-reduced (after treating DPC/RuPt-3-Calc in 50 mL min⁻¹ H₂ flow at 400° C. for 3 h) (a) ethene and ethane productivity; (b) acetylene conversion and ethene selectivity, with and without airflow along with reactant gas flow of 10 mL min⁻¹ C₂H₂ (10% in Ar), 5 mL min⁻¹ H₂ balanced by Ar to make the total flow 100 mL min⁻¹ at 1 bar pressure and visible light illumination (400-1100 nm) with a light intensity of 2.7 W cm⁻².

FIG. S4 illustrates acetylene semi-hydrogenation over DPC/RuPt-5-Calc (a) ethene and ethane productivity; (b) acetylene conversion and ethene selectivity, with reactant gas flow of 10 mL min⁻¹ C₂H₂ (10% in Ar), 5 mL min⁻¹ H₂ balanced by Ar to make the total flow 100 mL min⁻¹ at 1 bar pressure and visible light illumination (400-1100 nm) with a light intensity of 2.7 W cm⁻².

FIG. S5 illustrates acetylene semi-hydrogenation over DPC/RuPt-5-reduced (after treating DPC/RuPt-5-Calc in 50 mL min⁻¹ H₂ flow at 400° C. for 3 h) (a) ethene and ethane productivity; (b) acetylene conversion and ethene selectivity, with and without airflow along with reactant gas flow of 10 mL min⁻¹ C₂H₂ (10% in Ar), 5 mL min⁻¹ H₂ balanced by Ar to make the total flow 100 mL min⁻¹ at 1 bar pressure and visible light illumination (400-1100 nm) with a light intensity of 2.7 W cm⁻².

FIG. S6 illustrates acetylene semi-hydrogenation over DPC/RuPt-10-Calc (a) ethene and ethane productivity; (b) acetylene conversion and ethene selectivity, with reactant gas flow of 10 mL min⁻¹ C₂H₂ (10% in Ar), 5 mL min⁻¹ H₂ balanced by Ar to make the total flow 100 mL min⁻¹ at 1 bar pressure and visible light illumination (400-1100 nm) with a light intensity of 2.7 W cm⁻².

FIG. S7 illustrates acetylene semi-hydrogenation over DPC/RuPt-10-reduced (after treating DPC/RuPt-10-Calc in 50 mL min⁻¹ H₂ flow at 400° C. for 3 h) (a) ethene and ethane productivity; (b) acetylene conversion and ethene selectivity, with and without airflow along with reactant gas flow of 10 mL min⁻¹ C₂H₂ (10% in Ar), 5 mL min⁻¹ H₂ balanced by Ar to make the total flow 100 mL min⁻¹ at 1 bar pressure and visible light illumination (400-1100 nm) with a light intensity of 2.7 W cm⁻².

FIG. S8 illustrates acetylene semi-hydrogenation over DPC/RuPt-20-Calc (a) ethene and ethane productivity; (b) acetylene conversion and ethene selectivity, with reactant gas flow of 10 mL min⁻¹ C₂H₂ (10% in Ar), 5 mL min⁻¹ H₂ balanced by Ar to make the total flow 100 mL min⁻¹ at 1 bar pressure and visible light illumination (400-1100 nm) with a light intensity of 2.7 W cm⁻².

FIG. S9 illustrates acetylene semi-hydrogenation over DPC/RuPt-20-reduced (after treating DPC/RuPt-20-Calc in 50 mL min⁻¹ H₂ flow at 400° C. for 3 h) (a) ethene and ethane productivity; (b) acetylene conversion and ethene selectivity, with and without airflow along with reactant gas flow of 10 mL min⁻¹ C₂H₂ (10% in Ar), 5 mL min⁻¹ H₂ balanced by Ar to make the total flow 100 mL min⁻¹ at 1 bar pressure and visible light illumination (400-1100 nm) with a light intensity of 2.7 W cm⁻².

FIG. S10 illustrates (a) acetylene semi-hydrogenation over DPC/RuPt-10-Calc (a) at different concentrations of acetylene in the total feed at a fixed H₂:C₂H₂ ratio of 5:1, the total flow of 100 mL min⁻¹, visible light illumination (400-1100 nm) with a light intensity of 2.7 W cm-2 at 1bar pressure; (b) at different H₂:C₂H₂ ratios with acetylene concentration in the feed was fixed to be 3%, total flow of 100 mL min⁻¹, visible light illumination (400-1100 nm) with a light intensity of 2.7 W cm⁻² at 1 bar pressure; (c) at different total flows with C₂H₂:H₂:Ar=3:15:82, visible light illumination (400-1100 nm) with a light intensity of 2.7 W cm⁻² at 1 bar pressure.

FIG. S11 illustrates long-term stability of DPC/RuPt-10-Calc catalyst for non-competitive acetylene semi-hydrogenation, with 400-1100 nm illumination at 2.7 W cm-2, 1 bar pressure, optimized flow conditions-C₂H₂:H₂:Ar=3:15:82, the total flow of 100 mL min-1.

FIG. S12 illustrates acetylene semi-hydrogenation over DPC/RuPt-10-Calc (after treating deactivated DPC/RuPt-10-Calc (100 h) in 50 mL min⁻¹ air flow at 400° C. for 3 h (a) ethene and ethane productivity; (b) acetylene conversion and ethene selectivity, with and without airflow along with reactant gas flow of 30 mL min⁻¹ C₂H₂ (10% in Ar), 15 mL min⁻¹ H₂ balanced by Ar to make the total flow 100 mL min-1at 1 bar pressure and visible light illumination (400-1100 nm) with a light intensity of 2.7 W cm⁻².

FIG. S13 illustrates (a) production rate of ethene and ethane; (b) acetylene conversion and ethene selectivity at a total flow rate of 10.5 mL min⁻¹ (1.5 mL min⁻¹ H_{2, 3} mL min⁻¹ C₂H₂ (10% in Ar), 5.5 mL min⁻¹ Ar, 0.5 mL min⁻¹ air) and visible light illumination (400-1100 nm) with a light intensity of 2.7 W cm⁻².

FIG. S14 illustrates production rate of ethene and ethane, acetylene conversion, and ethene selectivity for acetylene semi-hydrogenation in excess ethene over DPC/RuPt-10-Calc at different concentrations of acetylene in feed (H₂:C₂H₂=5:1, C₂H₄:C₂H₂=20:1 and 1320000 mL g⁻¹ h⁻¹ GHSV, visible light illumination (400-1100 nm) with light intensity of 2.7 W cm⁻²).

FIG. S15 illustrates acetylene conversion and ethene selectivity for acetylene semi-hydrogenation in excess ethene over DPC/RuPt-10-Calc at different light intensities (400-1100 nm) (Flow: 3% acetylene in feed, H₂:C₂H₂=5:1, C₂H₄:C₂H₂=20:1 and 1320000 mL g⁻¹ h⁻¹ GHSV).

FIG. S16 illustrates (a) Light intensity-activity relation (log scale) for DPC/RuPt-10-Calc; (b) Quantum efficiency at different light intensities.

FIG. S17 illustrates acetylene conversion and ethene selectivity for acetylene semi-hydrogenation in excess ethene over DPC/RuPt-10-Calc at different wavelengths (at 2.7 W cm⁻²) (Flow: 3% acetylene in feed, H₂:C₂H₂=5:1, C₂H₄:C₂H₂=20:1 and 1320000 mL g⁻¹ h⁻¹ GHSV).

FIG. S18 illustrates acetylene semi-hydrogenation in excess ethene over (a) DPC/Pt-1-Calc; (b) DPC/Ru-9-Calc at different temperatures in the dark (Flow: 3% acetylene in feed, H₂:C₂H₂=5:1, C₂H₄:C₂H₂=20:1 and 1320000 mL g⁻¹ h⁻¹ GHSV).

FIG. S19 illustrates acetylene semi-hydrogenation in excess ethene over DPC/RuPt-10-Calc with and without air (3% acetylene in feed, 5:1 H₂:C₂H₂ ratio, C₂H₄:C₂H₂=20:1 and 1320000 mL g⁻¹ h⁻¹ GHSV, visible light illumination (400-1100 nm) with light intensity of 2.7 W cm⁻²).

FIG. S20 illustrates XPS analysis of DPC/RuPt-10-Calc-Au (4f) showing Au in the elemental state.

FIG. S21 illustrates XPS analysis of DPC/RuPt-10-ASP (a) Ru (3d); (b) Pt (4f); (c) Au (4f).

FIG. S22 illustrates pore size distribution of different catalysts using nitrogen sorption isotherms.

FIG. S23 illustrates (a) Quartz flat cell flow reactor setup employed to increase the illuminated catalyst area (b) Acetylene conversion and ethene selectivity trend showing high selectivity being maintained at high conversion. The highest conversion was achieved with a total flow of 9 mL min⁻¹, C₂H₂/C₂H₄/H₂/Ar/Air-0.2/4/2/1.8/1 ml min⁻¹ and AM1.5 illumination at 1 bar pressure. Quartz flat cell flow reactor dimensions: the internal gap is 0.5 mm in the flat section, length-50 mm, width-8 mm.

FIG. S24 illustrates electric field enhancement in (a) DPC, (b) DPC/RuPtOₓ, and (c) DPC/RuPt using FDTD simulations.

FIG. S25 illustrates electric field enhancement in DPC/RuPtOₓ at different light intensities using FDTD simulations.

FIG. S26 illustrates electric field enhancement in DPC/RuPtOₓ at different wavelengths using FDTD simulations.

FIG. S27 illustrates KIE dependence on light intensity and temperature (in the dark).

FIG. S28 illustrates activation energy vs. temperature plot for acetylene semi-hydrogenation over DPC/RuPt-10-Calc calculated using the Arrhenius equation.

FIG. S29 illustrates intensity-temperature study for acetylene semi-hydrogenation in excess ethene over DPC/RuPt-10-Calc; (a) moles of acetylene converted (log scale) v/s light intensity (log scale) used at different reactor temperatures (T_{R}); (b) Variation of catalyst bed temperature (Tₛ) with different light intensities at different reactor temperatures with 3% acetylene in feed, 5:1 H₂:C₂H₂ ratio, C₂H₄:C₂H₂-20:1 and 1320000 mL g⁻¹ h⁻¹ GHSV, visible light illumination (400-1100 nm).

FIG. S30 illustrates Raman spectroscopic analysis of different spent catalysts to determine graphitic carbon formation.

FIG. S31 illustrates thermogravimetric analysis of DPC/RuPt-10-spent (without air) for 3 h in airflow (40 mL min⁻¹) from 30° C. to 1000° C. showing no coke formation and Ru oxidation.

FIG. S32 illustrates PXRD analysis of spent and calcined samples showing the formation of Ru-hcp during the reaction.

FIG. S33 illustrates XPS analysis (Pt 4f), (a) DPC/RuPt-10-spent (with air); (b) DPC/RuPt-10-spent (without air).

FIG. S34 illustrates H₂-TPR analysis of DPC/RuPt-10-Calc with 20% H₂ flow showing reduction at ˜130° C.

FIG. S35 illustrates FTIR spectra of DPC/RuPt-10-Calc with and without heating at 100° C. in Ar for 60 min to remove adsorbed moisture.

### DETAILED DESCRIPTION OF THE INVENTION

As discussed hereinbefore, the present invention provides for hybrid catalytic nanoreactor having selectivity and stability in presence of air for reduction reactions including semi-hydrogenations comprising of light harvesting dendritic plasmonic colloidosomes (DPC) of gold and co-acting synergistically active catalytic sites of Pt-doped Ru bimetallic nanoparticles for desired significantly special selectivity and air-stability as a plasmonic reduction catalyst favoring plasmon-mediated simultaneous reduction and oxidation of metal active sites for facilitating reduction reactions including semi-hydrogenation activity.

It is thus a significant finding of the present invention that Pt-doped Ru nanoparticles loaded ‘dendritic plasmonic colloidosomes (DPC)’ [also known as black gold] of the present invention, were surprisingly found to be a highly active, selective, and notably air-stable plasmonic reduction catalyst for reduction reactions including acetylene semi-hydrogenation.

While reduction catalysts are generally unstable in the presence of air, the present invention comes as a surprising finding that the present plasmonic reduction catalyst is surprisingly stable only in the presence of air. By loading Pt-doped Ru nanoparticles on ‘dendritic plasmonic colloidosomes (DPC)’, also known as black gold, a highly active, selective, and notably air-stable plasmonic reduction catalyst for acetylene semi-hydrogenation could be achieved. The DPC/RuPt catalyst outperformed nearly all previously reported catalysts with over 90% selectivity and productivity of 320 mmol g⁻¹ h⁻¹ of ethene. The critical role of co-existing metal oxide and metal phase was evidenced by high catalytic activity and long-term stability for at least 100 h, which could only be achieved by providing continuous airflow along with the reactant feed. Plasmon-mediated simultaneous reduction and oxidation of the active site during the reaction were responsible for the unprecedented stability of the catalyst. By carrying out the finite-difference time-domain (FDTD) simulations and investigating the simultaneous effects of reactor temperature and light intensity as well as the kinetic isotope effect (KIE), the mechanism of plasmonic activation was comprehended. FDTD simulations showed a five-fold enhancement in the electric field as compared to pristine DPC due to the near-field coupling between the RuPt nanoparticles with DPC. This electric field, predominantly concentrated around the RuPt sites within the gaps of Au nanoparticles, was crucial in activating chemical bonds by inducing polarization in their vicinity. The KIE measured in light was larger than in the dark at all temperatures, implying the contribution from the non-thermal effects along with the photothermal activation of the reactants. Various mechanistic studies and spectroscopic analyses (XPS) demonstrated the cooperativity between Ru and Pt in achieving good ethene productivity and selectivity. In-situ FTIR studies and quantum chemical calculations provided insight into the molecular reaction mechanism over the oxide surface and highlighted the role of the intermediates in determining selectivity.

### The Main Finding of the Present Invention

The present invention thus for the first time reports a hybrid nanoreactor synthesized by impregnating Pt doped Ru clusters over Dendritic Plasmonic Colloidosomes (DPC) of gold as a plasmonic catalyst for semi hydrogenation. The design involves two components—a light harvesting material-DPC, also known as black gold (Au is deposited on Dendritic Fibrous Nano Silica (DFNS) using cycle by cycle approach), which is known to harvest a broad region of visible light and generate hot-spots owing to the coupling of Local Surface Plasmonic Resonances (LSPRs) at individual gold nanoparticle, and the catalytic site-Pt alloyed Ru clusters (Ru:Pt=90:10) which have been previously shown to selectively hydrogenate carbonyl to alcohols. The catalytic site was carefully chosen as Pt is well known for H₂ dissociation and Ru, relatively less reactive, was explored for the first time for its role in controlling the extent of hydrogenation. The developed catalyst is a unique fusion of a light harvester, featuring plasmonic black gold, and bimetallic active sites composed of Ru—Pt nanoparticles, enabling efficient hydrogenation processes. Notably, the catalyst of the present invention exhibits exceptional stability for a minimum of 100 hours, surprisingly while flowing air alongside the reactants—a significant achievement, as it marks the first reported instance of air stability for a hydrogenation catalyst. Moreover, unlike conventional hydrogenation catalysts, it requires no hydrogenation pre-treatment, streamlining the process. Through meticulous spectroscopic analysis, the critical role of oxide active sites of the catalyst was unveiled, that continuously generated as air flows with the reactant feed, contributing significantly to the catalyst's enhanced performance. Operating at an impressively high Gas Hourly Space Velocity (GHSV), the catalyst of the present invention showcases unparalleled ethene productivity, yielding approximately 320 mmol g⁻¹h⁻¹, with an outstanding selectivity of around 90% in the presence of excess ethene. This achievement surpasses previous records by more than double.

### Examples

### Plasmonic Acetylene Semi-Hydrogenation Over DPC/RuPt.

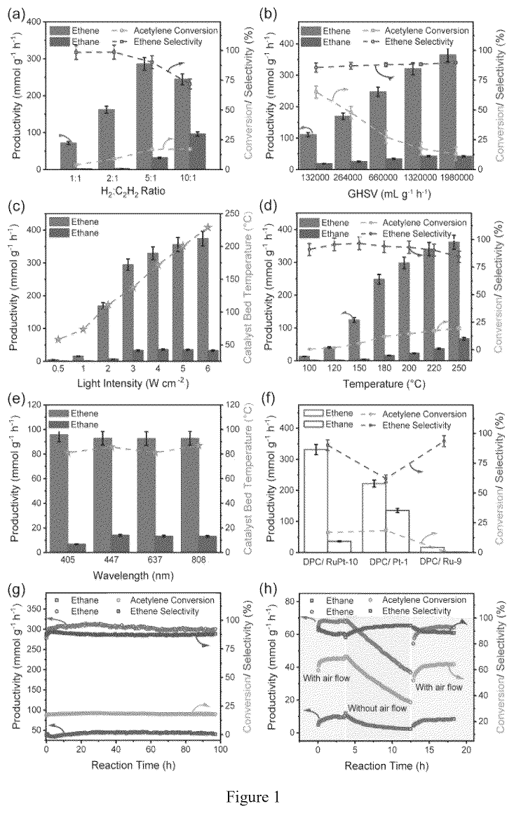

Polyvinylpyrrolidone impregnated (PVP)-stabilized RuPt clusters over DPC with various loadings (3, 5, 10, and 20 wt %) (FIG. S1, Table S1-2), naming catalysts as DPC/RuPt-wt %. The resultant as-prepared catalyst (named ASP) was then calcined to remove PVP in the air at 800° C. (named Calc). Non-competitive acetylene semi-hydrogenation was carried out in a flow reactor at 1 bar pressure with a total flow of 100 mL min⁻¹ (C₂H₂/H₂/Ar=1/5/94) under the illumination of visible light (Xenon lamp, 400-1100 nm, 2.7 W cm⁻²) and the products were monitored using online micro-gas chromatography (GC) (Scheme S1). The preferred best-performing catalyst DPC/RuPt-10-Calc was used for further studies (FIG. S2-13). Plasmonic acetylene semi-hydrogenation in excess ethene using the flow reactor was then conducted. First, the acetylene percentage (FIG. S14) and H₂:C₂H₂ ratio (FIG. 1a) in the reactant feed were selected. Then the GHSV using 5 mg of DPC/RuPt-10-Calc at 1 bar pressure under Xenon light (2.7 W cm⁻²) was selected. Under the select conditions, the ethene productivity of 320 mmol g 1 h 1 was achieved with GHSV (Gas Hourly Space Velocity), of 1320000 mL g 1 h 1 (total gas flow-110 mL min⁻¹) (FIG. 1b). With a further rise in the space velocity, the increment in productivity was much less to compensate for the loss in conversion, which dipped below 20% due to decrease in the residence time of the reactant gases on the active sites.

Photocatalytic acetylene semi-hydrogenation activity was carried out under different light intensities without external heating (FIG. 1c, S15). The catalytic activity showed super linear dependence of ethene production on the light intensity with a power law exponent of 2.37 (rate ∝ Iⁿ), indicating a hot electron-mediated non-thermal pathway (FIG. 1c, FIG. S16a). Notably, the quantum efficiency of this reaction first increased with an increase in light intensity (up to 3 W cm⁻²) and then decreased with a further increase in light intensity (FIG. S16b). This indicated the transition from non-thermal to thermal pathways at higher intensities. The catalyst bed temperature (Ts) was also measured at every light intensity using a thin thermocouple inserted directly into the catalyst's powder bed to determine the contribution of plasmonic photothermal effects (Scheme S1-2). The catalysis was then carried out in the dark at different temperatures to understand the photothermal effect (FIG. 1d). The best productivity of ˜300 mmol g⁻¹ h⁻¹ was achieved at Ts=200° C. (in the dark) by external heating, similar to what was achieved at 3 W cm⁻² (Ts=137° C.). This indicated the role of both thermal and non-thermal effects and the possibility of lowering the activation energy barrier during plasmonic catalysis. The catalytic reaction was then carried out at various wavelengths (FIG. 1e, S17, Scheme S3) in the visible region. However, the productivity at different wavelengths was comparable owing to the broadband absorption of black gold. The Ts values also indicated a similar trend.

The activities of DPC/RuPt-10-Calc with their monometallic versions were compared, DPC/Pt-1-Calc and DPC/Ru-9-Calc (FIG. 1f, S18). Notably, Ru was relatively inactive towards acetylene semi-hydrogenation, while Pt was less selective towards ethene in light and dark. DPC/RuPt-10-Calc outperformed both its monometallic counterparts, indicating the synergy between Ru and Pt to retain excellent productivity and high selectivity towards ethene. The catalyst was then tested for long-term stability up to ˜100 h. It was observed that flowing air along with the reactant feed could result in the long-term stability of the catalyst with negligible loss in its activity (FIG. 1g), which was not the case without flowing air (FIG. 1h, S19). A similar behavior was observed during the non-competitive acetylene semi-hydrogenation, where the activity dropped to ˜20% of its initial value in 100 h without airflow (FIG. S11). Interestingly, the activity could be recovered by high-temperature air treatment (FIG. S12). The in-depth characterizations of the spent catalysts were performed to understand the air-enhanced stability and is discussed in later sections.

### Structural Characterization of the DPC/RuPt Catalysts.

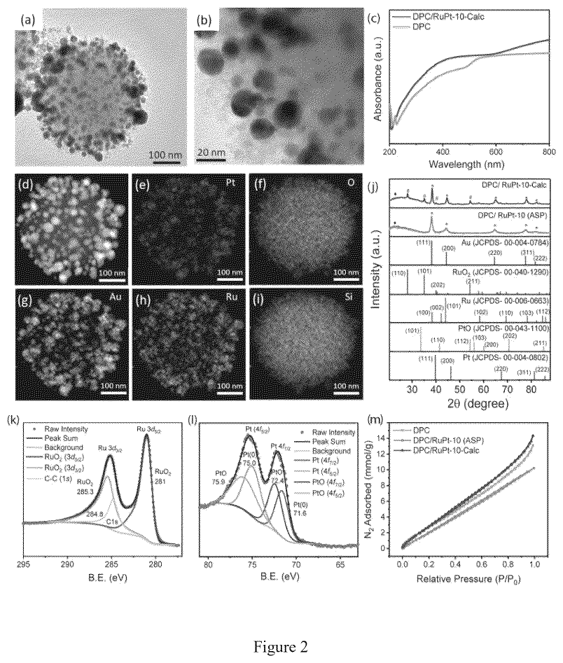

Various characterization techniques were employed to correlate the catalytic performance of the catalysts with their physical and chemical properties. The transmission electron microscopy (TEM) images and energy dispersive X-ray spectroscopy (EDS) of DPC/RuPt-10-Calc showed successful loading of RuPt NPs on the DPC sphere (FIG. 2a-b, d-i). To test if the broadband absorption of DPC was altered during the loading and calcination procedure, UV-vis spectra were recorded for DPC and DPC/RuPt-10-Calc. Both samples showed a similar broadband absorption in the visible region (FIG. 2c). The PXRD patterns of DPC/RuPt-10-Calc showed peaks corresponding to RuO₂ and Au. In contrast, only Au peaks appeared for as prepared sample (DPC/RuPt-10-ASP) (FIG. 2j), confirming the oxidation of loaded Ru NPs during calcination. XPS also indicated the presence of RuO₂ (281, 285.3 eV). The oxidation of Pt to PtO was shown by the XPS peaks corresponding to PtO (72.4, 75.9 eV) along with Pt (71.6, 75.0 eV). (FIG. 2k-1). The shift of +0.5 eV in Pt (0) could be attributed to the interaction with Ru. A similar positive shift was also observed in Au 4f peaks (FIG. S20). The DPC/RuPt-10-ASP showed XPS peaks corresponding to Ru, four peaks of carbon from PVP, Pt (0), and Au (0) (FIG. S21).

The nitrogen sorption isotherms of these catalysts showed typical type-II curves with weak hysteresis (FIG. 2m). The Brunauer-Emmett-Teller (BET) surface area (SA) of DPC/RuPt-10-ASP was similar to DPC (355 m² g⁻¹) with pore volume reduction from 0.41 to 0.31 cm³ g⁻¹, indicating the PVP-stabilized NPs occupying the pores. In contrast, the DPC/RuPt-10-Calc sample showed a higher SA of ˜415 m² g⁻¹ with a pore volume of 0.45 cm³ g⁻¹. The higher SA and pore volume of DPC/RuPt-10-Calc than DPC could be due to the loss of 3-aminopropyltricthoxysilane, used in DPC synthesis, during calcination at 800° C. (FIG. S22, Table S3).

Comparison with the Best Reported Catalytic Systems.

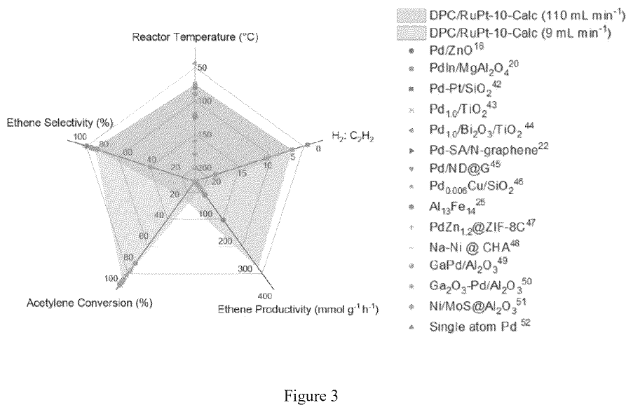

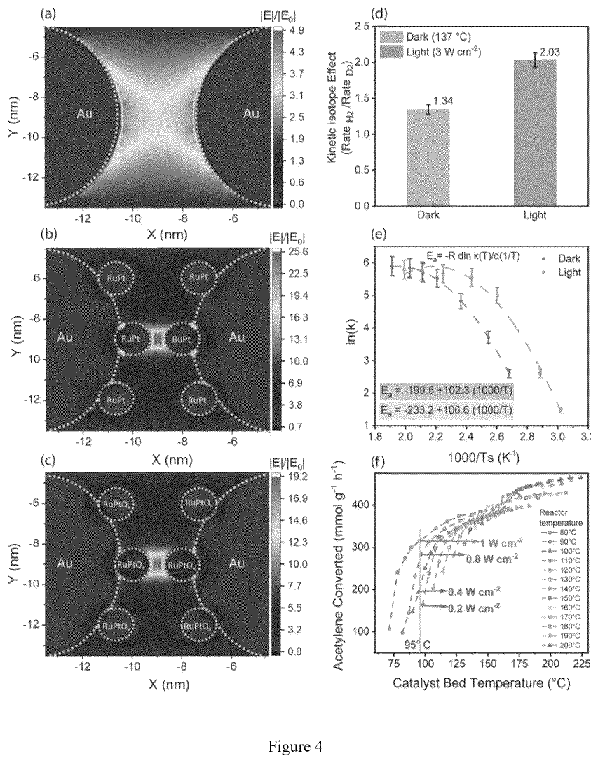

The catalytic performance of DPC/RuPt-10-Calcwas compared with best-reported catalysts for acetylene semi-hydrogenation in excess ethene in terms of ethene productivity, selectivity, acetylene conversion, H₂:C₂H₂ ratio, and reactor temperature (FIG. 3, Table 1 & S4). DPC/RuPt-10-Calc was first compared only with the previously reported plasmonic catalysts and showed the maximum ethene productivity among all the reported catalysts (Table 1). Notably, it also maintains high selectivity at higher acetylene conversions. In addition to the plasmonic catalysts, DPC/RuPt-10-Calc outperformed the best-reported thermal and photo-thermal catalysts (FIG. 3, Table S4). It showed the highest ethene production rate (320 mmol g⁻¹ h⁻¹) and high selectivity (˜87%) at a comparatively lower H₂:C₂H₂ ratio (5:1) and low Tₛ of 130° C. and reactor temperature (T_{R}, scheme S1) of 75° C. It also showed unprecedented stability for at least 100 h compared to all other reported thermal catalysts (FIG. 3, Table S4). The highest ethene production rate reported to date was 130 mmol g⁻¹ h⁻¹ (Table S4) for Pd/ZnO system, while our catalyst showed 320 mmol g⁻¹ h⁻¹ ethene production, i.e., >2 times higher only by shining solar light. The highest productivity was achieved with a total gas flow of 110 mL min⁻¹, but the acetylene conversion at such high space velocity was moderate, i.e., 20%. At a lower flow rate of 9 mL min⁻¹ and higher illumination intensity of 3.5 W cm⁻², the conversion value of ˜97% could be achieved while maintaining ˜90% selectivity and ethene productivity of 31 mmol g⁻¹ h⁻¹ (FIG. S23). The pentagon (FIG. 3) spanned by DPC/RuPt-10-Calc is much larger than those by the best-reported catalysts. This indicates that DPC/RuPt-10-Calc exhibited the best acetylene conversion and ethene productivity for acetylene semi-hydrogenation in excess ethene, with lower reactor temperature, a lower H₂:C₂H₂ ratio of 5:1, and showed excellent stability for at least 100 h.

TABLE 1
Activity comparison of plasmonic catalytic systems employed for acetylene semi-hydrogenation.

| Catalyst | | | | Ethene | | | |
|---|---|---|---|---|---|---|---|
| (metal | Light | | | Production | Acetylene | Ethene | |
| loading and | Intensity | Feed Composition | | Rate | Conversion | Selectivity | |
| weight) | (λ) | in vol. % (total flow) | Reactor Type | (mmol g⁻¹ h⁻¹) | (%) | (%) | Ref. |
| DPC/RuPt | 2.7 W cm⁻² | C₂H₂/C₂H₄/H₂/Ar/Air = | Fixed bed flow | 320 | 18 | 88 | This |
| (10%, | (400-1100 nm) | 2.72/54.5/13.6/24.5/4.5 | reactor with | | | | Work |
| Ru:Pt = 9:1, | | (110 mL min⁻¹) | quartz window | | | | |
| 5 mg) | | With excess ethene | (crucible | | | | |
| | | | i.d-6 mm) | | | | |
| DPC/RuPt | 6 W cm⁻² | C₂H₂/C₂H₄/H₂/Ar/Air = | Quartz flat cell | 31 | 97 | 87 | This |
| (10%, | (AM1.5) | 2.2/44.4/22.2/20/11.1 | flow reactor | | | | Work |
| Ru:Pt = 9:1, | | (9 mL min⁻¹) | (internal gap is | | | | |
| 20 mg) | | With excess ethene | 0.5 mm in the | | | | |
| | | | flat section, | | | | |
| | | | length-50 mm, | | | | |
| | | | width-8 mm) | | | | |
| Pd—Mg/GS | 1.8 W cm⁻² | C₂H₂/H₂/N₂ = 5/15/75 | Horizontally- | NR | 90 | 80 | 39 |
| (Pd:3%, | (785 nm) | C₂H₂/H₂/N₂ = 5/20/75 | oriented packed | | | | |
| 20 mg) | | (Total flow: 5-200 | bed reactor with | | | | |
| | | mL min⁻¹) | CaF₂ window | | | | |
| | | Without ethene | (6 mm) at the | 101 | NR | NR | |
| | | | top of the reactor | | | | |
| DPC/Ni | 0.58 W cm⁻² | C₂H₂/H₂/Ar = | Quartz flat cell | 2.4 | 30 | 86 | 40 |
| (Ni-10%, | (400-1100 nm) | 0.12/2/97.8 (Total flow- | flow reactor | | | | |
| 35 mg) | | 14 mL min⁻¹) | (tube i.d-3.5 mm) | | | | |
| | | Without ethene | | | | | |
| Au—Fe/C | 0.45 Wcm⁻² | C₂H₂/C₂H₄/H₂/Ar = | Photothermal | 0.5 | 98.4 | 97.5 | 26 |
| (1%, | (250-1100 nm) | 1/20/20/59 (Total flow- | fixed-bed reactor | | | | |
| Au:Fe = 1:1, | T~130° C., | 20 mL min⁻¹) | | | | | |
| 1 g (in 2 g | external | With excess ethene | | | | | |
| quartz sand)) | heating) | | | | | | |
| AlNC—Pd | 14.3 Wcm⁻² | C₂H₂/H₂/He/N₂ = | Stainless steel | 26.7 × 10⁻³ | 5 | 97 | 41 |
| (catalyst | (680-1080 nm) | 1.33/3.33/25.33/70 | gas-phase high- | (mmol h⁻¹) | | | |
| weight | | (Total Flow = | temperature | | | | |
| unknown) | | 15 mL min⁻¹) | reaction chamber | | | | |
| | | Without ethene | | | | | |

### Mechanism of Plasmonic Activation by Light.

Plasmonic activation involves many pathways, including concentrating the electric field around the nanoparticle and facilitating bond polarization. To visualize the local electric field enhancement resulting from the LSPR, FDTD simulations were conducted. The present model included RuPt NPs (1.5 nm) deposited on Au nanospheres (10 nm) with a separation of 3 nm. Impact of RuPt NPs on electric field enhancement was investigated (at light intensity: 2.7 W cm⁻², Eo=4509 V m⁻¹). Notably, without RuPt NPs (only DPC), a modest electric field enhancement of 4.9 was observed, with less concentration at the center (FIG. 4a). However, the presence of RuPt on DPC resulted in a significant electric field enhancement of 25.6 (five times that of DPC) (FIG. 4b, S24), owing to the near-field coupling between the RuPt NPs with DPC. The electric field was predominantly concentrated around the RuPt sites within the gaps of Au NPs (FIG. 4b, S24). Partially reduced RuPt sites (in the model DPC/RuPtOₓ) were investigated which exhibited similar behavior to DPC/RuPt but with a lower enhancement factor of 19.2 (still four times higher than that of DPC) (FIG. 4c, S24). This small decrease in enhancement can be attributed to the reduced metallic character of RuPt sites affecting their near-field coupling to Au. The dependence of this enhancement on light intensity and wavelength (FIG. S25-S26) showed a negligible effect of the impinged light intensity, but enhancement was highest at around 550 nm. The heightened electric field was crucial in activating chemical bonds by inducing polarization in their vicinity.

The decay of plasmonic resonance generates hot carriers (electrons and holes) within femtoseconds and localized heating (electron-phonon coupling) within picoseconds due to LSPR damping, which can then activate the reactants in different ways. To understand these plasmonic pathways in the current catalytic study, KIE was investigated, which depends on the nature of the activation pathway. The reactions driven by electrons (non-thermal pathway) have larger KIEs than reactions driven by phonons (thermal pathway). The KIE was obtained as a ratio of ethene productivity using H₂ and D₂ in light with the light intensity of 3 W cm⁻² and in the dark at 137° C. Notably, KIE measured in light (2.03) was found to be larger than that measured in the dark (1.34) (FIG. 4d). Same trend was observed at various light intensities and corresponding catalyst bed temperatures (FIG. S27), implying that there was a contribution from the non-thermal effects along with the photothermal activation of the reactants.

The Arrhenius plots, as a function of Tₛ in light and dark, showed a convex nature, indicating the temperature dependence of activation energy Ea (FIG. 4c). This convex nature could be due to change in adsorption and desorption kinetics of reactants at higher temperatures and light intensities, although this needs to be further studied for in-depth understanding. The Ea values were plotted as a function of Ts in FIG. S28. The Ea with light was smaller than that in the dark at all temperatures, which was also evident from the Arrhenius plot. The reaction rate in the presence of light was higher than that in the dark in the low Ts region and became comparable at higher Ts (1000/Ts ˜1.9).

To elucidate the contribution of non-thermal and photothermal effects, the acetylene semi-hydrogenation in excess ethene was carried out at various light intensities along with external heating. The rate of conversion of acetylene over DPC/RuPt-10-Calc was plotted as a function of Ts under visible light illumination (FIG. 4f) (400-1100 nm), and the reactant gas flow of 110 mL min⁻¹ (30 mL min-1C₂H₂ (10% in Ar), 60 mL min⁻¹ C₂H₄, 15 mL min⁻¹ H₂, 5 mL min⁻¹ air). The light intensities were varied from 0.2 to 3 W cm⁻², and the reactor's temperature (T_{R}) was varied from 80 to 200° C. The Tₛ value was measured at different light intensities for a constant T_{R} (FIG. S29). Tₛ value was determined by the contributions from the reactor's heat supply and photothermal heating by light. It was observed that at similar Tₛ in the low-temperature range, the rate of acetylene conversion was higher when the light intensity was higher. For instance, the Tₛ reached 95° C. when T_{R} was set to 80° C., and the catalyst was illuminated with a visible light of the intensity of 1 W cm⁻². The same Tₛ (95° C.) was obtained by setting the T_{R} to 110° C. and illuminating the catalyst with the light of low intensity (0.2 W cm⁻²). If the catalysis proceeds via only the photothermal pathway, similar conversion rates should be observed in both conditions. However, the reaction rate under a higher light intensity (1 W cm⁻²) was double that under a lower light intensity (0.2 W cm⁻²). This trend was not observed at higher temperatures (>125° C.) as the activity became saturated with a conversion rate close to ˜400 mmol g⁻¹ h⁻¹. The comprehensive evaluation of temperature and light intensity variation showed the importance of non-thermal effects, which predominated at lower light intensities. It is difficult to disentangle the contribution of thermal and nonthermal effects at higher catalyst bed temperatures above 125° C. (which can be reached at higher light intensities) where the reaction reaches saturation.

### Role of Air in Enhancing Catalyst Stability.

The DPC/RuPt-10-Calc catalyst underwent continuous deactivation during the semi-hydrogenation of acetylene without flowing air (FIG. S11, S19, 1h). Surprisingly, the catalyst was stable when the air was flown with the reactant feed, and the initial activity could be maintained for at least 100 h (FIG. 1g). The reason for the deactivation in the absence of air could be then thought of as the formation of coke, which blocks the active sites. However, Raman spectroscopic analysis of this spent catalyst showed no peaks corresponding to graphitic carbon: 1370 cm⁻¹ (D-band) and 1590 cm⁻¹ (G-band) (FIG. S30), indicating no graphitic coke formation. TGA of the spent catalyst (FIG. S31) also showed no weight loss, confirming no coke formation. The TGA analysis, however, showed a ˜2% weight gain in the range of 400-700° C., which could be due to the re-oxidation of in-situ reduced metal sites.

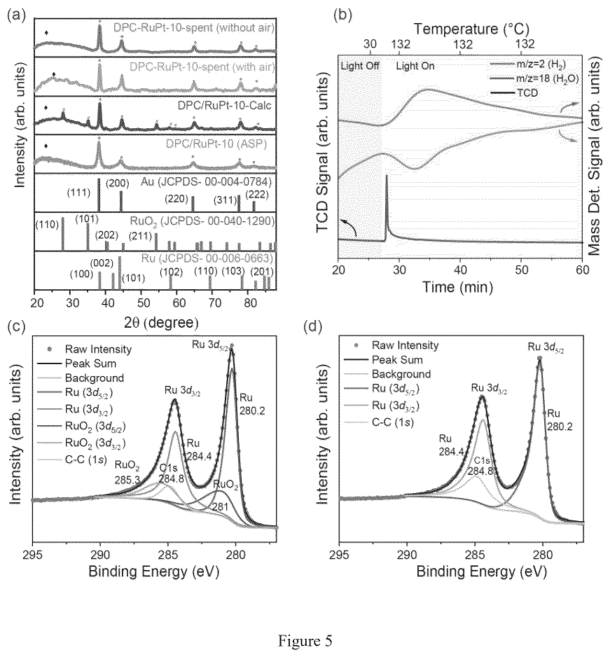

XRD analysis of fresh catalyst showed the peaks corresponding to RuO₂ for the calcined sample (FIG. 5a), which, however, were absent in both the spent catalysts (with or without flowing air), indicating that in-situ reduction of RuO₂, which was also indicated by the slight increase in the peak intensity corresponding to Ru-hcp (FIG. S32). To further investigate the oxide phase composition of the spent catalysts, the X-ray Photo electron Spectroscopy (XPS) were recorded for fresh and spent catalysts (FIG. 5, S33). The oxidation state of Ru in spent catalysts (in the absence of air) by XPS showed a complete reduction of RuO₂ to Ru in the deactivated catalyst, whereas only partial reduction was observed for the spent catalyst in the presence of air (FIG. 5c-d).

To know if the temperature reached by light illumination of the plasmonic catalyst was sufficient to reduce the oxide, the TPR of DPC/RuPt-10-Calc in the presence of H₂ (20% in Ar) was carried out. A reduction occurred at ˜130° C. (FIG. S34), which was similar to the Tₛ achieved by illuminating light. This indicated the possibility of light-induced metal oxide reduction during photocatalysis. Light-induced reduction analysis of the metal oxide phase was also conducted to confirm that the loss of activity was associated with the in-situ catalyst reduction. The mass detector signal for H₂ decreased as soon as the light (2.7 W cm⁻²) was switched on, indicating a light-induced reduction of the oxide phase (FIG. 5b). This confirmed the possibility of metal oxide reduction to metal during plasmonic catalysis. It was evident from these studies that the Ru—O phase was crucial for the catalytic activity of the DPC/RuPt catalyst, and air in the reactant feed preserved the Ru—O phase. Recently, Ramirez et al. in Albani, D., Capdevilla-Cortada, M., Vile, G., Mitchell, S., Martin, O., López, N., Pérez-Ramírez, J. Semihydrogenation of Acetylene on Indium Oxide:Proposed Single-Ensemble Catalysis. Angew. Chem., Int. Ed. 56, 10755-10760 (2017) reported a similar deactivation in acetylene semi-hydrogenation over In₂O₃ at higher temperatures (>300° C.), which was attributed to the formation of O vacancies. They showed that C₂H₂ adsorbs more strongly than H₂ to the oxide phase to form the In—CH—CH—O complex and that only at higher temperatures H₂ could interact to form hydroxy species, which later recombine to form water leading to oxygen vacancy and, thus, deactivation. In the case of the DPC/RuPt catalyst, the Ru—O phase acted as an adsorption site for acetylene. However, it underwent light-induced complete reduction during the reaction in the absence of air, leading to the deactivation of the catalyst. Supplying air along with the reactant feed prevented this complete in-situ reduction of the Ru-Ophase by re-oxidization. This simultaneous reduction and oxidation of the active site during the reaction were responsible for the high stability of the catalyst for at least 100 h.

### Mechanism of Acetylene Semi-Hydrogenation.

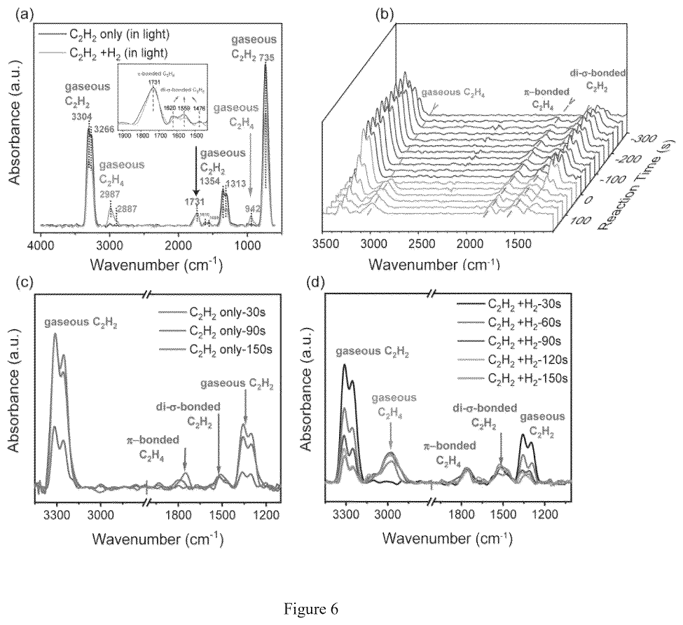

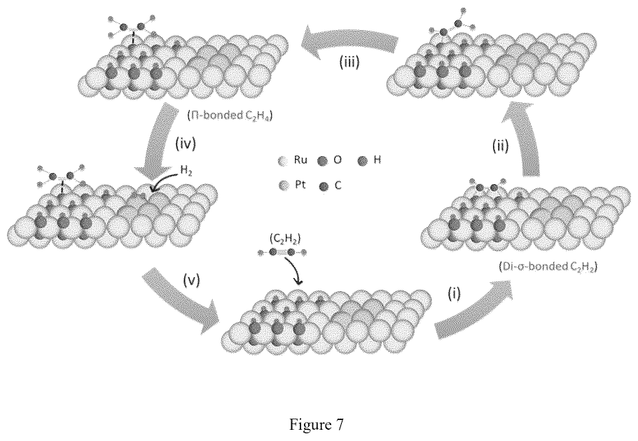

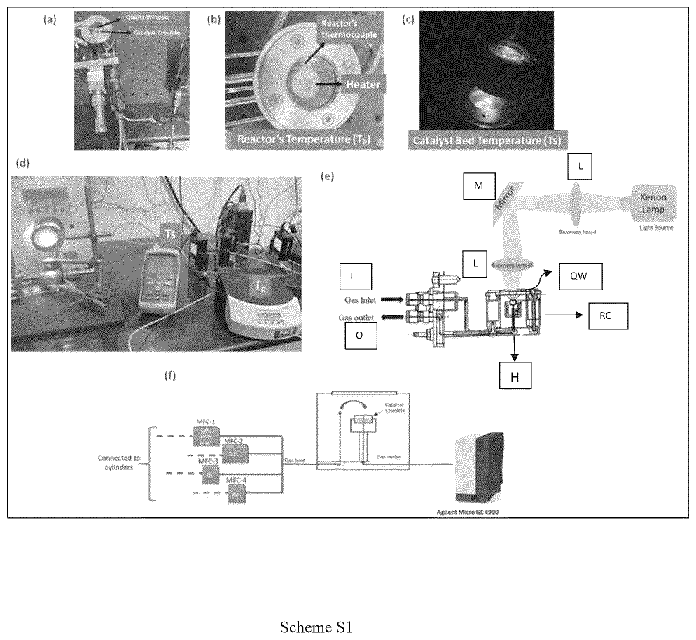

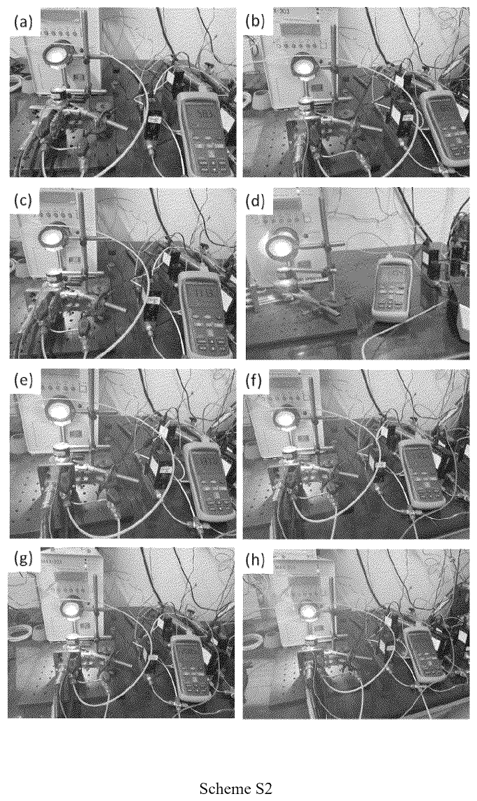

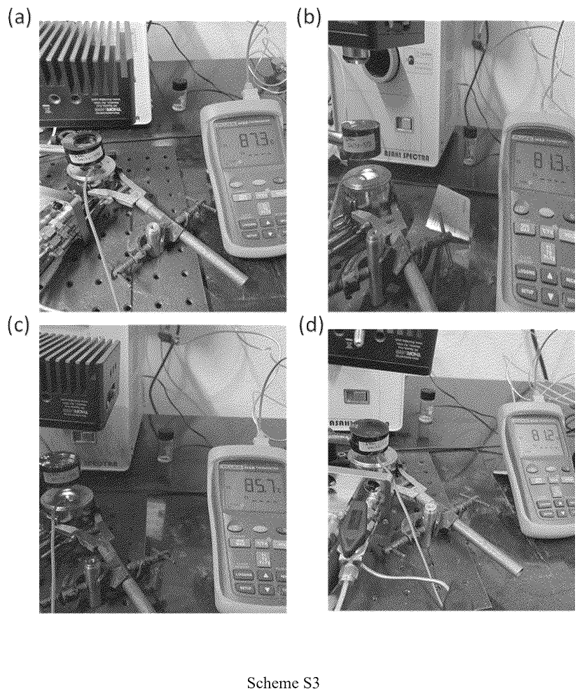

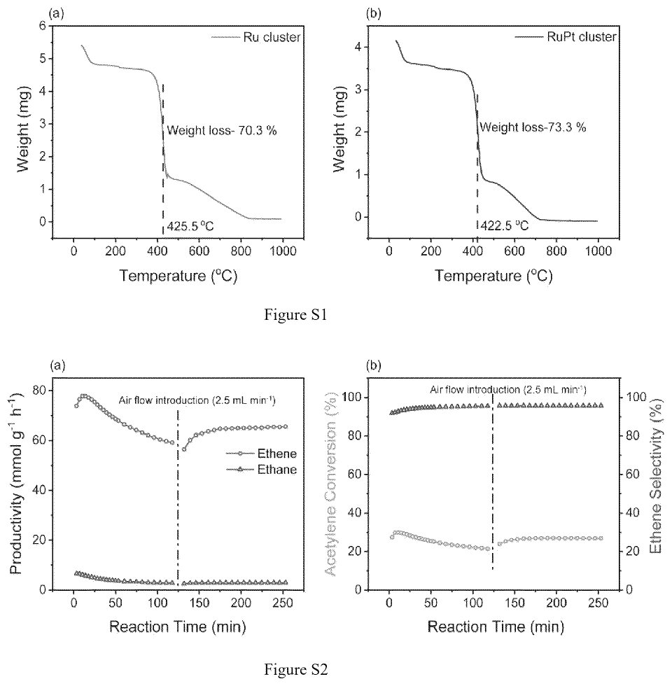

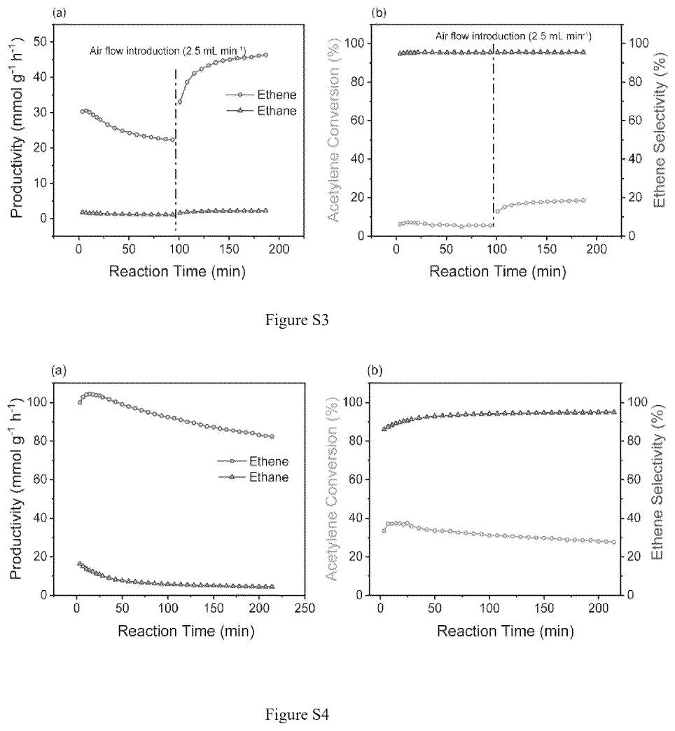

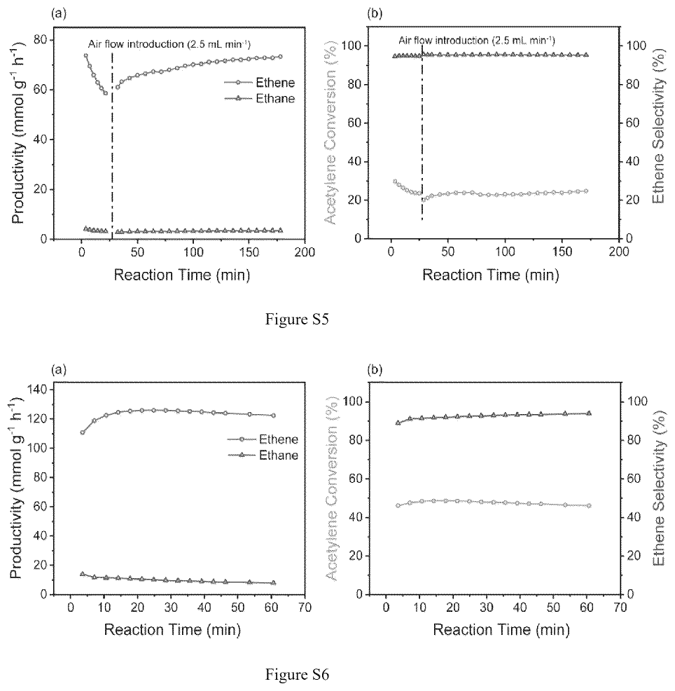

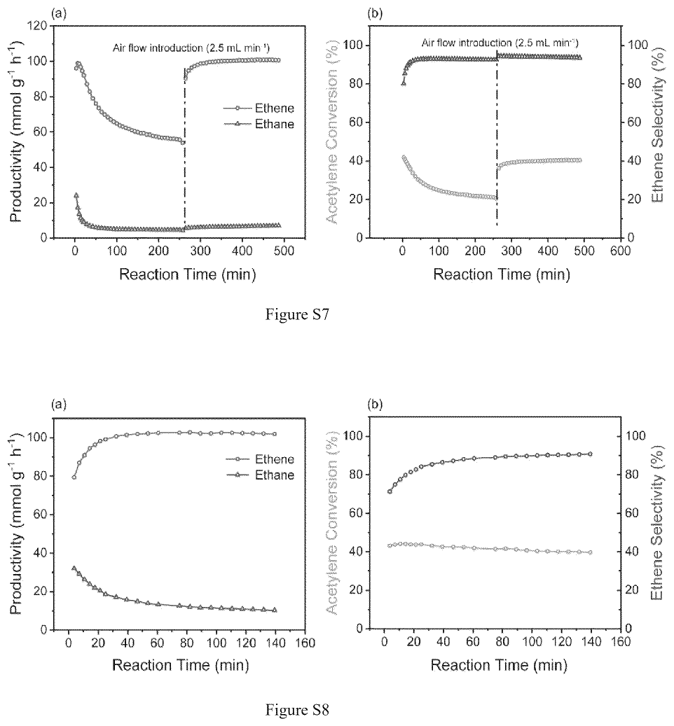

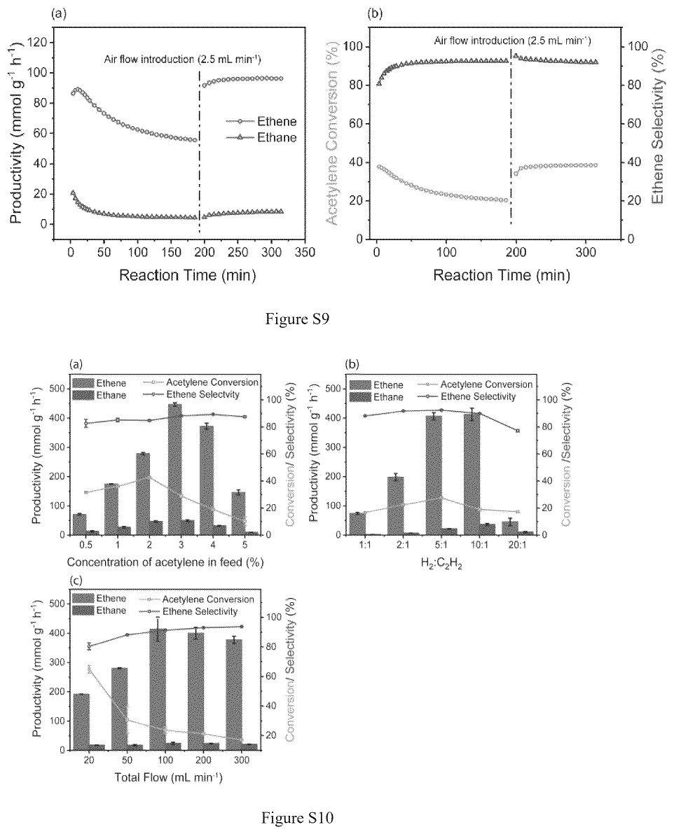

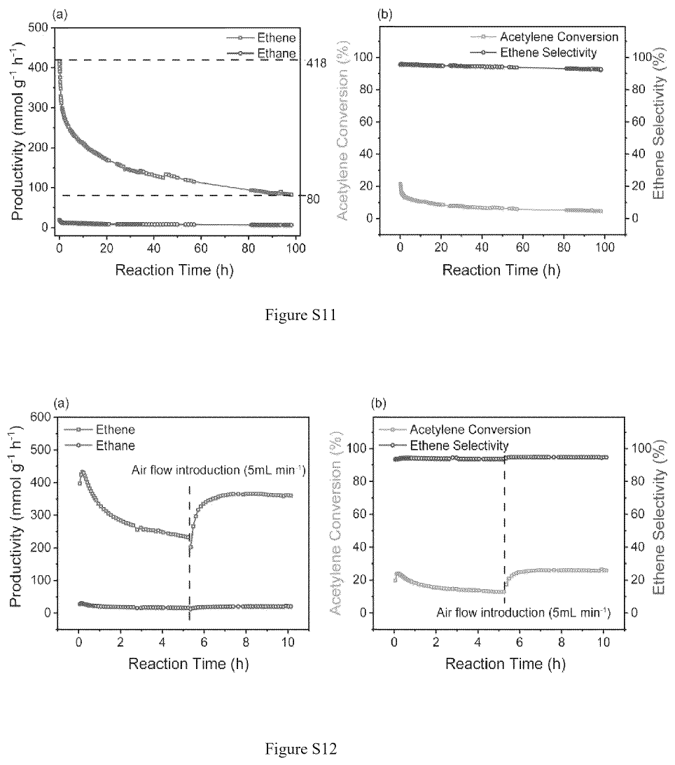

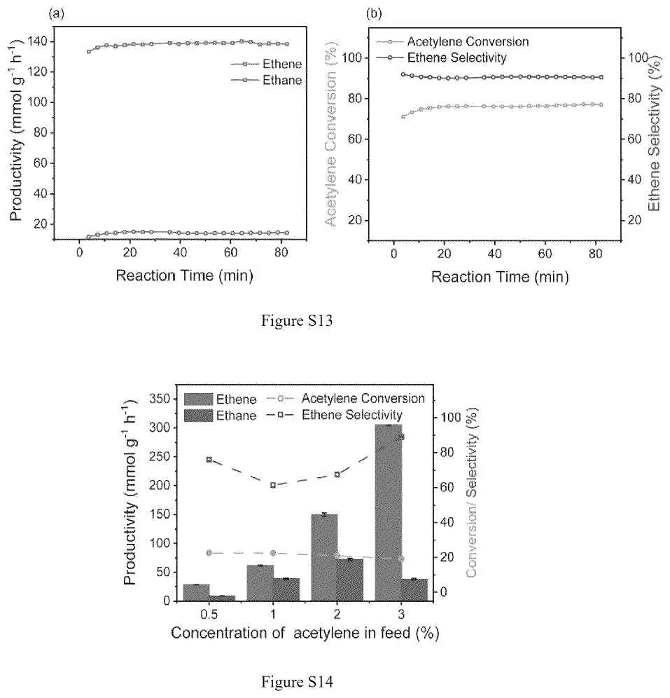

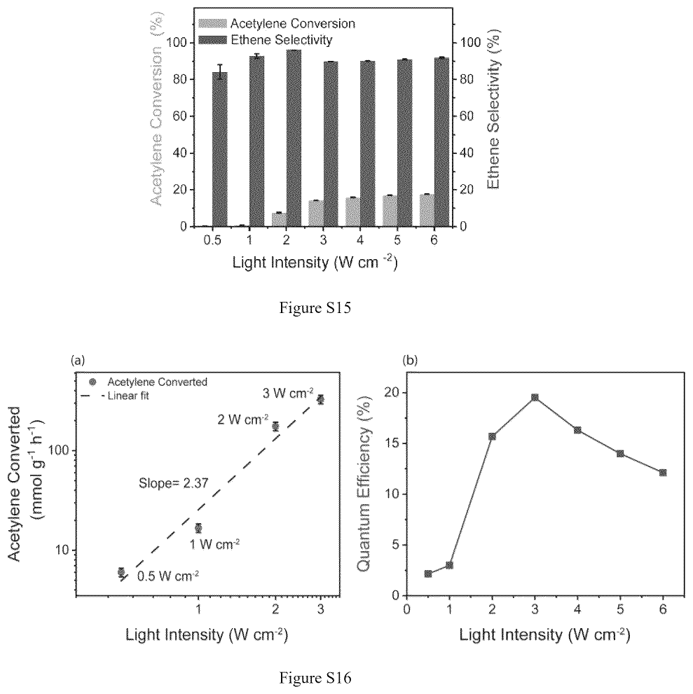

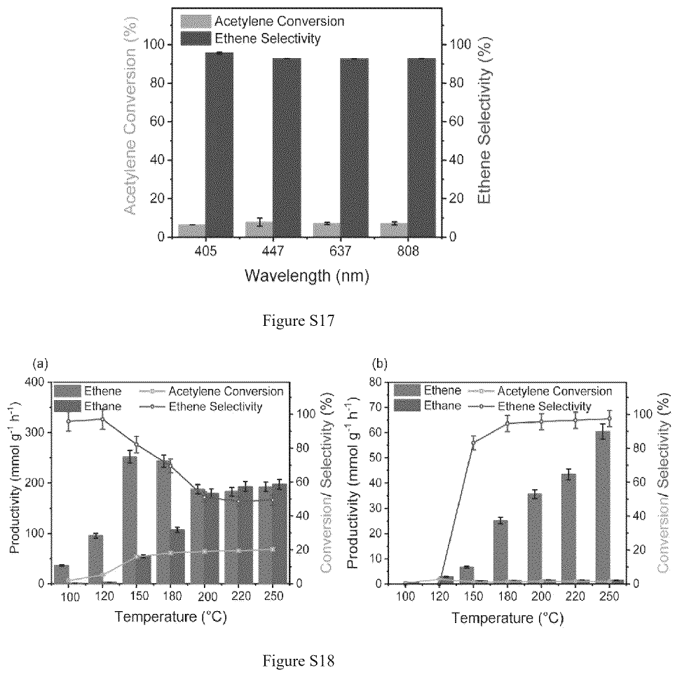

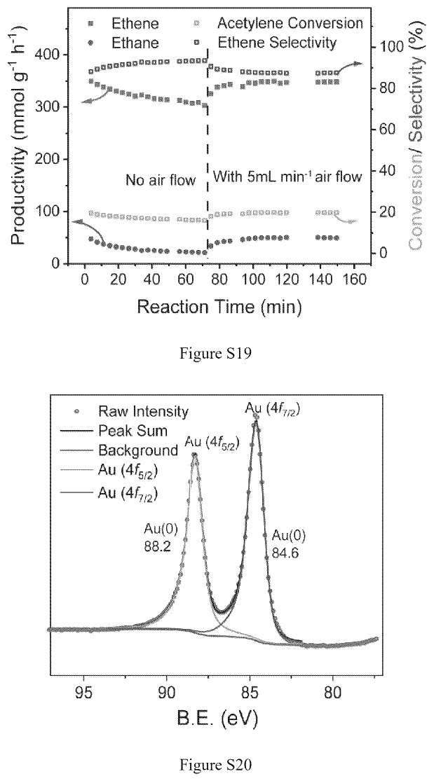

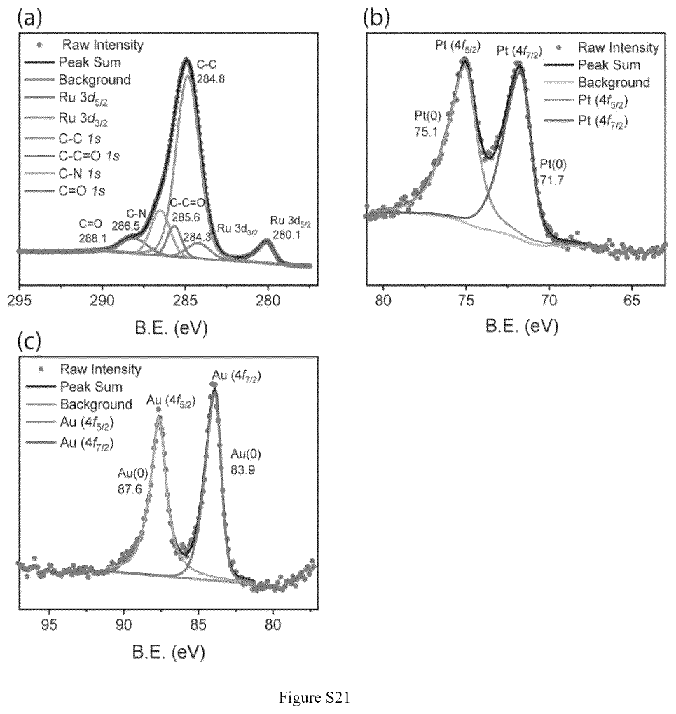

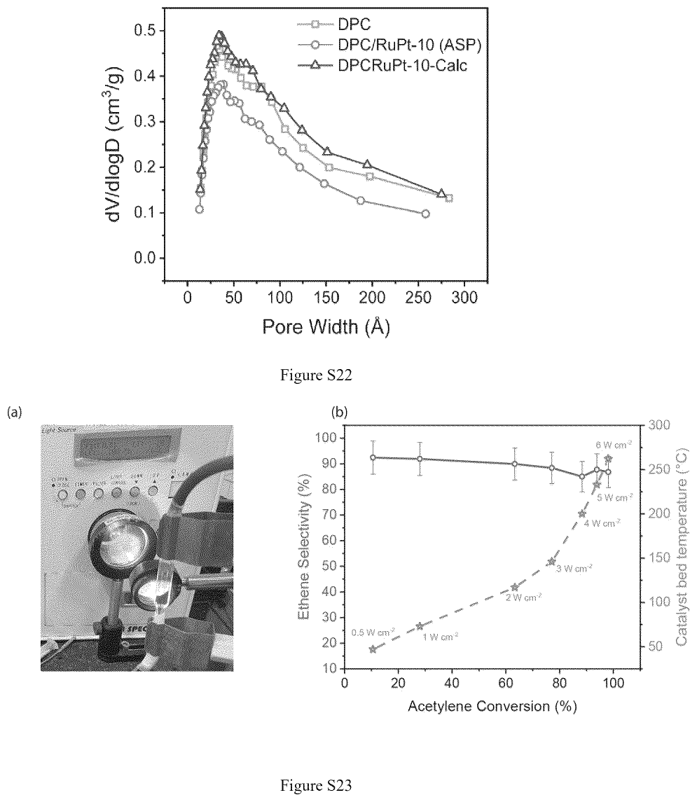

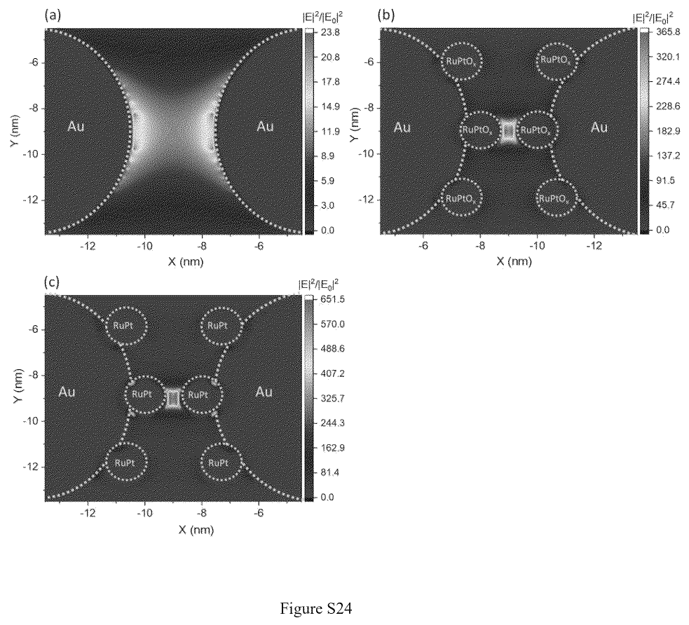

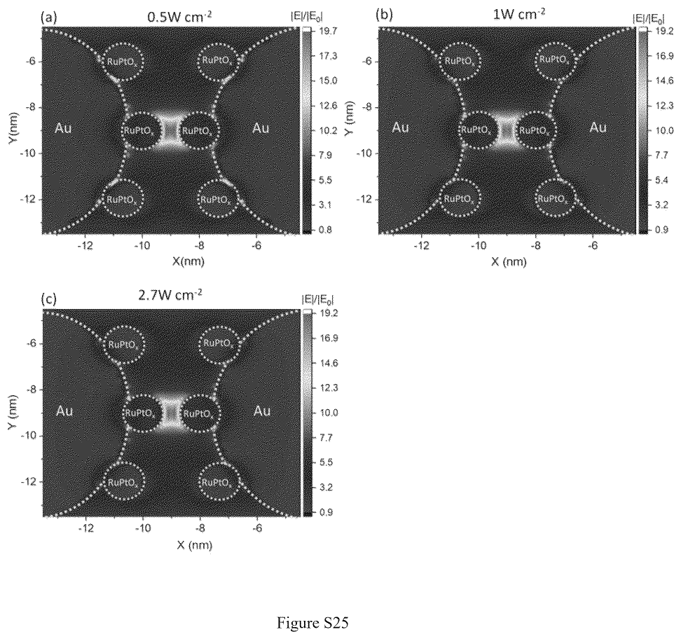

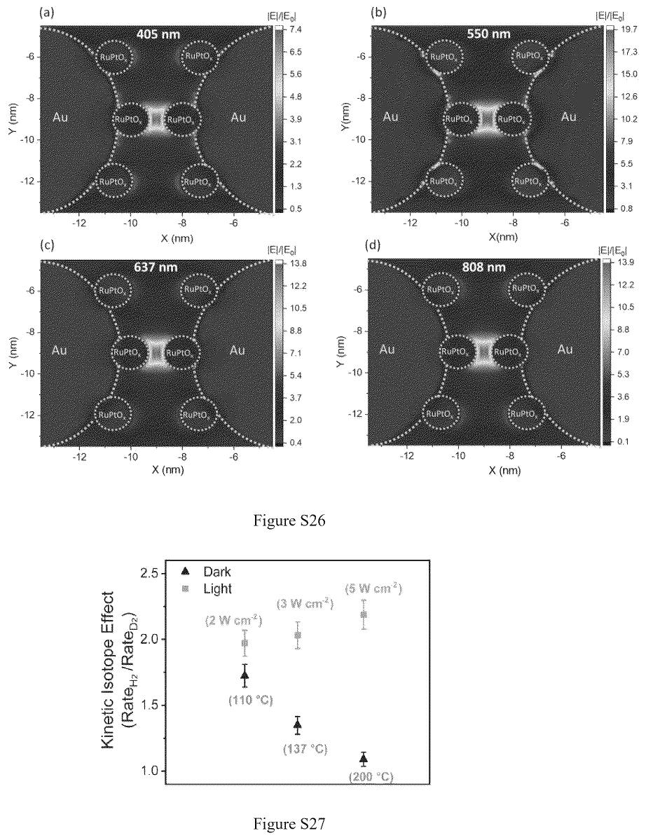

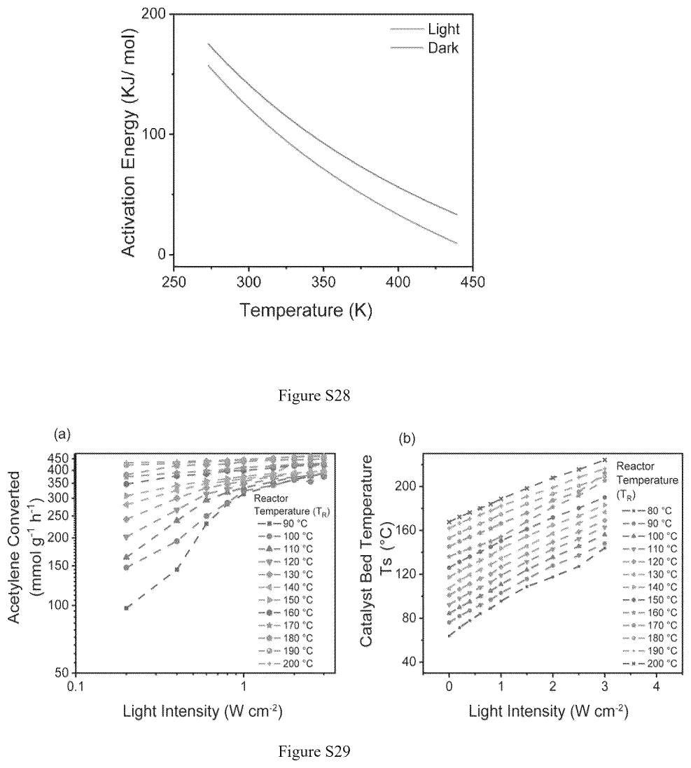

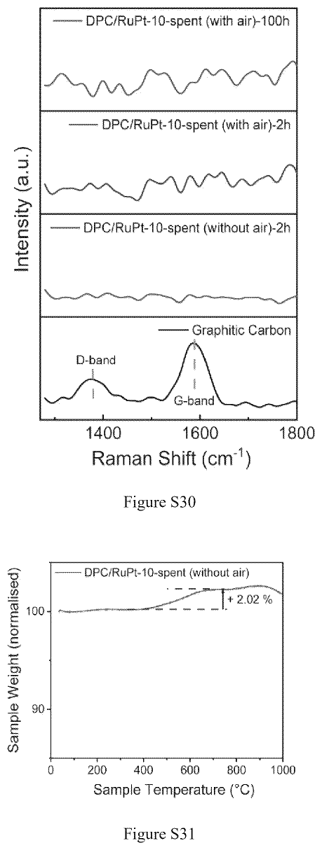

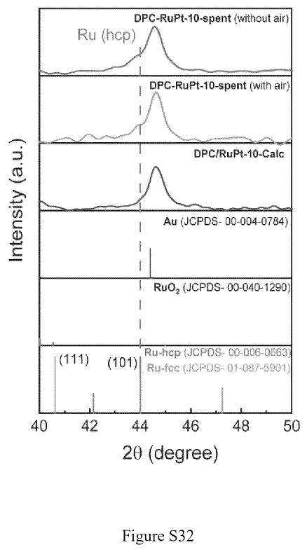

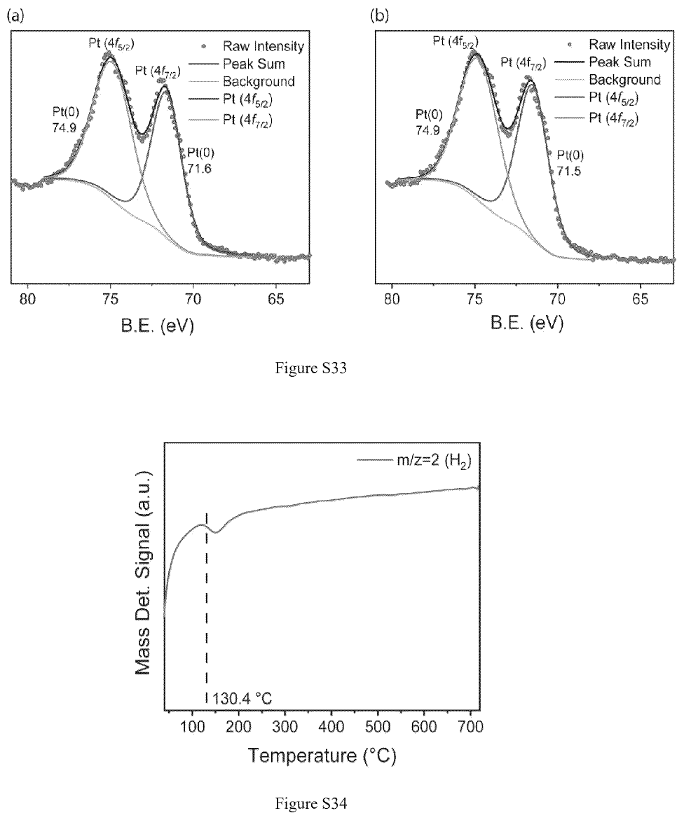

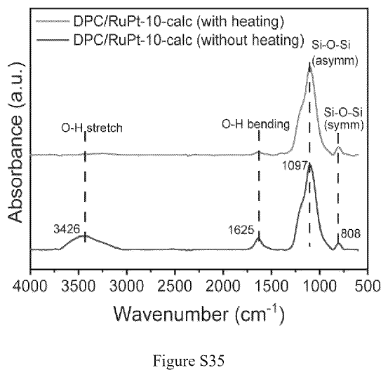

In-situ diffuse reflectance infrared Fourier transform spectroscopy (DRIFTS) was carried out under light illumination with and without H₂ to unravel the mechanism of acetylene semi-hydrogenation over DPC/RuPt-10-Calc. As evident from in-situ DRIFTS (FIG. 6a), after saturation with C₂H₂, three peaks appeared at 1620 cm⁻¹, 1559 cm⁻¹, and 1476 cm⁻¹, assigned to C═C stretching, C—O stretching and ═C—H bending modes of the di-σ-bonded acetylene respectively (FIG. 6a). Another peak at ˜1731 cm⁻¹ was assigned to ethene π-bonded to surface oxygen, observed even without supplying H₂. This observation highlights the significant role of surface hydroxyl in the first step of hydrogenation. The hydroxyl group was regenerated only after supplying H₂. The IR peaks due to gaseous ethene started to appear at ˜3000 cm⁻¹ and 900 cm⁻¹. corresponding to the ═C—H stretching and H—C—H out-of-plane wagging modes, respectively. Interestingly, the characteristic peak at 1255 cm⁻¹ corresponding to di-σ-bonded ethene was absent even after supplying H₂, indicating that ethene was weakly bound to the catalyst surface via n orbitals. The weak interactions caused efficient desorption of ethene from the catalyst surface, resulting in high selectivity towards ethene by suppressing further hydrogenation. In-situ FTIR (FIG. 6b) showed a series of spectra captured every 30 sec during C₂H₂ exposure (violet spectra) and subsequent reaction after H₂ was introduced (orange spectra) over the DPC/RuPt-10-Calc at 200° C. in transmission mode. The peak at ˜1750 cm⁻¹ due to π-bonded ethene increased along with the peaks for gaseous acetylene in the initial adsorption periods (FIG. 6c). Once the surface was saturated with acetylene and H₂, the peaks for gaseous ethene started to appear, while those for gaseous acetylene peaks began to decrease owing to the conversion of acetylene selectively to ethene (FIG. 6d). Because of their continual creation during the reaction, the peaks corresponding to π-bonded ethene and di-σ-bonded acetylene remained steady throughout the hydrogenation. Based on these observations, reaction mechanism was hypothesized for acetylene semi-hydrogenation over DPC/RuPt-10 (FIG. 7a). A partially oxidized RuPt alloy surface with a terminal hydroxyl group (as evidenced by the IR spectra in FIG. S35) interacted with acetylene and generated di-σ-bonded acetylene via the loss of 2H from the hydroxyl groups and the breaking of the triple bond to form two C—O bonds (step i). The hydrogen lost from hydroxyls was then utilized to form a ═C—H bond by breaking a C—O bond (step ii). After both the C—O bonds were broken, the ethene formed interacted with the O in a π-bonded fashion (step iii). After supplying external H₂, which was dissociated by the Pt sites of the RuPt catalyst, the hydroxyls were regenerated, and the ethene molecules were released, and the catalyst became available for the next cycle (step iv).

RuPt NPs could thus facilitate the dissociation and migration of H radicals across the surface in a controlled way (step v), which could then add to the activated di-σ-bonded acetylene at the RuO₂ phase, lowering the overall activation energy barrier. Without the RuO₂ phase, there would not be such an activation of acetylene. Moreover, there is an expected decrease in the extent of acetylene adsorption on the DPC/RuPt due to the negative charge accumulation on the metal surface and the π electron cloud, which may be the reason for the decreased stability of the reduced catalyst.

### Synthesis of Dendritic Plasmonic Colloidosome (Black Gold)

Dendritic plasmonic colloidosomes (DPC) were synthesized using a modified version of our previously published protocol/Dhiman, M., Maity, A., Das, A., Belgamwar, R., Chalke, B., Lee, Y., Sim, k., Nam, J.-M., Polshettiwar, V. Plasmonic Colloidosomes of Black Gold for Solar Energy Harvesting and Hotspots Directed Catalysis for CO₂ to Fuel Conversion. Chem. Sci. 10, 6594 6603 (2019)/. Refluxing DFNS/Maity, A., Belgamwar, R., Polshettiwar, V. Facile Synthesis Protocol to Tune Size, Textural Properties and Fiber Density of Dendritic Fibrous Nanosilica (DFNS): Applications in Catalysis and CO₂ Capture. Nat. Protoc. 14, 2177 2204 (2019)] (4 g) with APTES (4 mL, 17 mmol) in 250 mL of toluene at 80° C. for 24 h allowed the functionalization of DENS with APTES. The resultant solid was washed three times with 50 mL of toluene and three times with 50 mL of ethanol and then dried in an oven for ten hours at 80° C. to yield DFNS-APTS.DFNS-APTS (500 mg) was then dispersed in water (50 mL) using a sonicator for 15 minutes and stirred for an additional 10 minutes at room temperature. From a gold-stock solution containing 100 mg mL-1 of gold (III) chloride trihydrate salt, 43 mg was added dropwise. The reaction mixture was then sonicated for 15 minutes, followed by stirring for 2 hours at room temperature. Freshly prepared NaBH₄ solution (5 mL, 1 M in water) was then added to this dispersion, and it was then stirred for two hours at room temperature. The solid was isolated using centrifugation at 10,000 rpm for 10 minutes, followed by three washing with 30 mL each of water and ethanol. The resultant solid was dried at 80° C. in an oven for 2 h and was named DPC-CO, 0^{th} cycle.

The K-gold solution was prepared by dissolving 300 mg of HAuCl₄·3H₂O and 2800 mg of K₂CO₃ in 2 L of DI water. DPC-CO (500 mg) was then dispersed in 1000 mL of K-gold solution for the following C1 growth cycle. The solution was sonicated for 10 seconds and then stirred at room temperature for 10 minutes (200 rpm) followed by the addition of 5 mL of ammonium hydroxide (25%) and subsequent stirring for 15 minutes. Formaldehyde solution (90 mL, 37 wt % in H₂O) was then added, and the solution was stirred for 24 hours at room temperature. The solid product was isolated by centrifugation at 10,000 rpm for 10 minutes and washed three times with water (100 mL each time) and ethanol (100 mL each time). These growth steps were repeated, taking DPC-C1 as base material to obtain DPC-Cx with 2, 3, and 4 growth cycles. The resultant solid obtained after the 4th cycle, DPC-C4, was denoted as “black gold”, and used as the plasmonic support over which RuPt nanoparticles (NPs) were loaded.

The activity of the catalyst of the present invention is found to be directly related to the enhancement in electric field and hotspot formation in DPC (FIG. 4a-c). This hotspot formation due to plasmonic nature of gold is highly dependent on the interparticle distance and Au particle size which are very different for second and third cycle and have been controlled via cycle-by-cycle approach. This loading selection and its effect on plasmonic coupling has already been done in a previous work on DPC documented under Polshettiwar et al; Chem. Sci. 10, 6594-6603 (2019), and the select loading of 4th cycle was chosen to load RuPt particles. Due to high interparticle distance and weak plasmonic coupling for lower loadings, the activity for lesser cycles are significantly lower.

### Synthesis of RuPt Clusters

A previously established protocol was employed to synthesize Ru, Pt, and RuPt bimetallic clusters/Matsuda, S., Masuda, S., Takano, S., Ichikuni, N., Ts ukuda, T. Synergistic Effect in Ir- or Pt-Doped Ru Nanoparticles: Catalytic Hydrogenation of Carbonyl Compounds under Ambient Temperature and H₂ Pressure. ACS Catal. 11, 16, 10502 10507 (2021)/where an ethylene glycol (EG) reduction process was used. For synthesizing Ru NPs, RuCl₃·nH₂O and PVP (20 equivalence to Ru in monomer units of PVP) were dissolved in EG (10 mL/mmolpvp) and the mixture was stirred at 80° C. under Ar flow for 1 h. The mixture was heated to 180° C. and stirred for 1 hour in an Ar environment. PVP-stabilized Pt clusters (denoted as Pt) were also synthesized by the EG reduction method. NaOH (50 equivalence to Pt) and PVP (20 equivalence to Pt in monomer units of PVP) were dissolved in EG (10 mL/mmolpvp) and the H₂PtCl₆ was added to the solution, which was then stirred at 80° C. under Ar flow for 1 h. The mixture was further stirred for 3 hours at 140° C. in an Ar environment.

The same approach of Ru clusters synthesis was used to synthesize RuPt bimetallic NPs using H₂PtCl₆ and RuCl₃·nH₂O. The Ru:Pt atomic ratio was set at 90:10. The solution eventually turned dark brown while being stirred at 180° C. In all cases, the suspension was cooled to room temperature under stirring, and water was added to reduce viscosity. The colloidal metal clusters were deionized three times by ultrafiltration using a membrane filter with a cut-off molecular weight of 10 kDa before being collected as a powder by lyophilization.

### Synthesis of DPC/RuPt

For a typical 10 wt % loading of RuPt over black gold, 75 mg of RuPt bimetallic NPs (effective metal content˜2% (Table S1)) were dispersed in 15 mL ethanol in 250 mL RB flask and sonicated for 90 min. Black Gold (DPC-C4, 15 mg) was then added to this dispersion and again sonicated for 30 s. The mixture was then stirred at 60° C. under ambient conditions for 1 h and dried under vacuum at 80° C. for 2 h. The resultant powder (DPC/RuPt-10 (ASP)) was then calcined in a muffle furnace at 800° C. (10° C./min ramp) for 2 h to oxidize the as-prepared sample to DPC/RuPt-10-Calc.

### Catalysts Characterizations

Scanning transmission electron microscopy (STEM) analysis was carried out using FEI-TITAN operated at an accelerating voltage of 300 kV. Elemental mapping was performed using energy-dispersive X-ray spectroscopy (EDS). A small amount of solid powder was dispersed in ethanol by sonicating for 30 seconds, and the dispersion was drop-casted onto a holey carbon-coated 200 mesh copper TEM grid. PXRD patterns were obtained using a PANalyticalX′Pert Pro powder X-ray diffractometer with Cu—K radiation. A JASCO UV/vis/NIR spectrophotometer was used to conduct UV-Vis spectroscopic measurements. N₂ sorption measurements were performed using a Micromeritics 3-Flex surface analyzer (samples were degassed at 120° C. overnight under vacuum before analysis). The weight loss study was carried out by using thermogravimetric analysis (TGA) Mettler Toledo TGA-DSC2/LF/1100 in the Ar flow of 40 mL min⁻¹ (for PVP removal) and airflow of 40 mL min⁻¹ for coke formation analysis with 10° C. min⁻¹.

XPS analysis was carried out using a Thermo Kat spectrometer with micro-focused and monochromated Al-Kα radiation (1486.6 eV) as the X-ray source. The sample was prepared by sprinkling solid powder on carbon tape. The carbon signal at 284.8 cV was used as an internal reference. Raman measurements were performed at 633 nm using a Witec alpha300R confocal Raman microscope. The temperature-programmed reduction and light-induced reduction were conducted using a Catalyst Analyzer BELCAT II coupled with a Quadrupole mass spectrometer (Belmass). DPC/RuPt-10-Calc (30 mg) sample was loaded into a quartz reactor and was exposed to a 20.0 vol % H₂/Ar mixture (25 mL min⁻¹) and heated to 700° C. at a rate of 5° C./min.

### Plasmonic Acetylene Semi-Hydrogenation Using DPC/RuPt

Photocatalytic acetylene hydrogenation was carried out in a PIKE technologies flow reaction chamber with a quartz window equipped with a heater and a thermocouple to precisely measure the temperature of the catalyst bed and connected to a temperature controller (Scheme S1). The inlet of the flow reactor chamber was connected to mass flow controllers (MFCs), and the outlet was connected to an Agilent 490 MicroGC equipped with A CP-PoraPLOT U column and a thermal conductivity detector (TCD).

The catalyst (5 mg) was taken in a ceramic porous base crucible, which was placed inside the reactor chamber. Argon (Ar) gas (150 mL min⁻¹) flowed through the reactor for 10 minutes, and the reactant gases were then introduced into the reactor chamber through Alicat mass flow controllers; C₂H₂ (10% in Ar) at 30 mL min⁻¹, H₂ at 15 mL min⁻¹, C₂H₄ (60 mL min⁻¹) for competitive and Ar (55 mL min⁻¹) for non-competitive along with air (5 mL min⁻¹) constituting a total flow of 110 mL min⁻¹ (for competitive) and 105 mL min⁻¹ (for non-competitive) at 1 bar pressure. The catalyst was then irradiated with light (300 W Xenon Lamp ˜2.7 W cm-2, 400-1100 nm), and the progress of the reaction was monitored by using online MicroGC every 4 minutes. Higher temperature studies in the dark were performed by providing external heating to the catalyst bed by the heater inside the reaction chamber. For tests under different light intensities, the light power was tuned by changing the light intensity of the Xenon lamp (Scheme S2). The wavelength-dependent studies were conducted using diode lasers of various wavelengths, keeping the light intensity constant (Scheme S3). For quantification, the GC was calibrated by injecting known concentrations of standard gases like H₂, O₂, N₂, CO₂, CH₄, C₂H₄, C₂H₆, C₂H₂, and higher hydrocarbons till C₄. The slope of peak area versus ppm plot gives the calibration constant (area/ppm), which was used to calculate the product formation rate and selectivity of the products formed. Production rate, selectivity, conversion, and apparent activation energy were calculated using the below formulae, [Guo, Q., Qin, C., Guo, J., Chen, P. Selective Hydrogenation of Acetylene to Ethylene by Alkali-Metal Palladium Complex Hydrides. Chem. Commun. 59, 2259-2262 (2023)]

$${C}_{2} {H}_{2} Conversion ( \% ) = \frac{( C 2 H 2 in - C 2 H 2 out ) ( in p p m ) \times 100}{( C 2 H 2 in ) ( in p p m )}$$

$${C}_{2} {H}_{4} Productivity ( mmol {g}^{- 1} {h}^{- 1} ) = \frac{( C 2 H 2 in - C 2 H 2 out ) ( C 2 H 6 out - C 2 H 6 in ) ( in p p m ) \times Total}{Wt . of catalyst ( in a ) \times 22400 \times 1000}$$

$${C}_{2} {H}_{6} Productivity ( mmol {g}^{- 1} {h}^{- 1} ) = \frac{( C 2 H 6 out - C 2 H 6 in ) ( in p p m ) \times Total flow}{Wt . of catalyst ( in g ) \times 22400 \times 1000}$$

$${C}_{2} {H}_{4} Selectivity ( \% ) = \frac{C 2 H 4 Productivity}{C 2 H 4 Productivity + C 2 H 6 Produ}$$

In (k) was plotted as a function of 1000/Tₛ and apparent activation energy (Eₐ) was calculated by using the Arrhenius equation,

$$\text{?}$$

$$\text{?} \text{indicates text missing or illegible when filed}$$

where k_{C2H4} is ethene production rate
[Truhlar, D. G., Kohen, A. Convex Arrhenius Plots and their Interpretation. Proc. Natl. Acad. Sci. U.S.A 98, 848-851 (2001)].

### Quantum Efficiency Calculations

The calculation of the quantum efficiency of the DPC/RuPt catalyzed plasmonic acetylene semi-hydrogenation process.

Quantum Efficiency is defined as:

$$Quantum Efficiency ( \% ) = \frac{C 2 H 2 molecules reacted per unit time}{Number of photons absorbed by DPC / Rupt per unit time} \times 100$$

No. of photons absorbed by DPC/RuPt per unit time was calculated by the absorption spectra of DPC/RuPt and emission spectra of the Asahi Xenon Lamp used.

$$\text{?}$$

$$\text{?} \text{indicates text missing or illegible when filed}$$

In photocatalytic acetylene semi-hydrogenation by DPC/RuPt, light intensity was varied over the area spanning the catalyst crucible of diameter ˜0.47 cm. 1% is the percentage of the light intensity of Xe-lamp at a specific wavelength and A % is the absorption percentage of the catalyst at that specific wavelength. Time is 1 h (3600 sec) and N_{A} is the Avogadro constant. The average single photon energy is given by:

$$\text{?}$$

$$\text{?} \text{indicates text missing or illegible when filed}$$

In this equation, h is the planck's constant 6.626×10⁻³⁴ m² kg s⁻¹, c is the speed of the light in vacuum (3×10⁸ m s⁻¹), and λ is the wavelength of the photon.

### Finite Difference Time Domain (FDTD) Simulations

The electric field enhancement calculations were performed by the finite difference time domain method. For simulation, the Au NPs were modeled as spheres of 10 nm in diameter. 2 Au NPs at a distance of 3 nm from each other were modelled. The Au NPs were placed on a silica sheet of 5 nm thickness. This model was chosen to mimic DPC-C4, in which Au NPs are located close to each other. For the simulation of DPC/RuPtOₓ, spherical RuPt NPs (1.5 nm diameter) were attached to Au NPs. The composition of the NPs was assumed to be in 0.1:0.6:0.3 (Pt:Ru:RuO₂) molar ratio. DPC/RuPt was also modeled with 0.1:0.9 (Pt:Ru) molar ratio. The Au NPs were randomly decorated with these NPs to mimic the surface of DPC/RuPt-Calc. An x-polarized total-field scattered-field (TFSF) source having a wavelength range of 400 nm to 1100 nm and E₀ of 4509 V m⁻¹ (for light intensity-2.7 W cm⁻²) was used as the excitation source to mimic the photocatalysis conditions. E₀ was varied according to different light intensities (0.5 W cm⁻², 1 W cm⁻², 2.7 W cm⁻²). Frequency domain field profile monitors were used to calculate the electric field distribution in all the simulations. The dielectric constants of SiO₂, Au, and Pt were taken from the Handbook of Optical Constants of Solids, Ed. E. D. Palik, (Academic Press, 1985) and the refractive indices of RuPt NPs were calculated by following the Effective Medium Approximation/Humlicek, J. Data Analysis for Nanomaterials: Effective Medium Approximation, Its Limits and Implementation M. Losurdo and K. Hingerl (eds.), Ellipsometry at the Nanoscale 145-178 (Springer-Verlag Berlin Heidelberg 2013)/based on the Drude model where the permittivity of the composite was assumed to be the sum of individuals (Ru/El-Tantawy, F., Al-Ghamdi, A.A., Al-Ghamdi, A.A., Al-Turki, Y.A., Alshahrie, A., Al-Hazmi, F., Al-Hartomy, O. A. Optical Properties of Nanostructured Ruthenium Dioxide Thin Flms via Sol gel Approach. J Mater Sci: Mater Electron 28 (2017)], Pt, and RuO₂/Libowitzkey, E. TMPM Ts chermaks Min. Petr. Mitt. 35,27-32 (Springer-Verlag, 1986)/multiplied by their mole fraction.

### In-Situ DRIFT Study

Diffuse reflectance infrared Fourier transform spectroscopy (DRIFTS) measurements were performed on a JASCO FT/IR-4700 instrument with a DiffusIR™-PIKE Technologies high-temperature reaction chamber with KBr windows. The catalyst (5 mg) was taken in a ceramic porous base crucible, which was placed inside the reactor chamber. 10% C2H₂ (in Ar) was filled in the reactor by flowing 50 mL min⁻¹ gas for 15 min, the light of intensity 2 W cm⁻² was shone, and the spectra were recorded and averaged out using 2400 scans and with a resolution of 4 cm⁻¹. Then, the gas with a composition 10% C₂H₂-50 mL min⁻¹ and H₂-25 mL min⁻¹ was filled in the reactor by flowing for 15 min and the spectra were recorded under similar conditions. The spectra were recorded against the baseline of the Ar filled reactor (50 mL min⁻¹) in light.

### Time-Resolved In-Situ Transmission FTIR Study for Acetylene Semi-Hydrogenation

Time-resolved operando Fourier transform infrared (FTIR) spectroscopy measurements were carried out to study reaction intermediates and products of acetylene hydrogenation over DPC/RuPt-10-Calc. In-situ FTIR experiments were carried out using a Specac high-temperature transmission IR reaction cell with ZnSe windows and JASCO FT/IR-4700 equipment. 20 mg of the catalyst was pressed into a pellet of about 13 mm in diameter. This self-supporting catalyst pellet was then inserted in Specac's high-temperature transmission IR reaction cell. Ar (50 mL min⁻¹) flowed through the reactor at 200° C., and a baseline was taken with 36 scans and 4 cm⁻¹ resolution. To gain insights into the evolution of surface species over the DPC/RuPt catalyst, time-resolved experiments were performed by first saturating the catalyst with C₂H₂ flow (10% in Ar) of 50 mL min⁻¹ at 200° C. and then flowing H₂ at a rate of 25 mL min⁻¹ for sufficiently long times to stabilize the transmission FTIR signal.

TABLE S1
Effective metalcontent in Ru and Pt doped
Ru clusters determined by ICP-MS analysis.

| | | | Total metal |
|---|---|---|---|
| Sample | Ru (wt %) | Pt (wt %) | content (wt %) |
| Ru | 1.97 | — | 1.97 |
| RuPt | 1.78 | 0.29 | 2.07 |

TABLE S2
Elemental composition of different catalysts by SEM-EDS.

| Entry | Sample | Si (wt %) | O (wt %) | Au (wt %) | Ru (wt %) | Pt (wt %) |
|---|---|---|---|---|---|---|
| 1 | DPC/RuPt-3-Calc | 41.5 ± 7.0 | 16.9 ± 3.0 | 36.8 ± 10.1 | 4.7 ± 1.4 | — |
| 2 | DPC/RuPt-5-Calc | 49.1 ± 11.6 | 15.6 ± 3.2 | 29.1 ± 11.9 | 6.0 ± 2.8 | — |
| 3 | DPC/RuPt-10-Calc | 59.9 ± 10.6 | 12.5 ± 3.3 | 16.9 ± 7.6 | 10.5 ± 4.1 | 0.2 ± 0.4 |
| 4 | DPC/RuPt-20-Calc | 50.1 ± 9.3 | 11.0 ± 2.1 | 19.4 ± 6.6 | 18.3 ± 3.3 | 1.07 ± 0.8 |

TABLE S3
BET surface areas and BJH pore volumes of different catalysts.

| | BET Surface | BJH Pore |
|---|---|---|
| Sample | Area (m²/g) | Volume (cm³/g) |
| DPC | 356 | 0.41 |
| DPC-RuPt-ASP | 355 | 0.34 |
| DPC-RuPt-calc | 415 | 0.45 |

Standard error in measurement: ±10% in BET Surface area. ±0.02 in Pore Volume

TABLE S4
Comparison of acetylene semi-hydrogenation using thermal and photo-thermal catalysts.

| | | | | Ethene | Acetylene | Ethene | |
|---|---|---|---|---|---|---|---|
| | Catalyst (loading, | Temperature | Feed Composition | Productivity | Conversion | Selectivity | |
| Entry | weight) | (° C.) | (total flow) | (mmol/g_{cat}/h) | (%) | (%) | Ref. |
| 1 | DPC/RuPt-10-Calc | T_{R}-75 | C₂H₂/C₂H₄/H₂/Ar/Air = | 320 | 18 | 88 | Present Invention |
| | (10 wt %, 5 mg) | Ts-130 | 3/60/15/27/5 | | | | |
| | | with light- | (110 mL min⁻¹) | | | | |
| | | 2.7 W cm⁻² | | | | | |
| | | 400-1100 nm | | | | | |
| 2 | DPC/RuPt-10-Calc | Ts- 262 | C₂H₂/C₂H₄/H₂/Ar/Air = | 31 | 97 | 87 | Present Invention |
| | (10 wt %, 20 mg) | light 6 W cm⁻² | 2.2/44.4/22.2/20/11.1 | | | | |
| | | AM 1.5 | (9 mL min⁻¹) | | | | |
| 3 | Pd/ZnO | 80 | C₂H₂/C₂H₄/H₂/He = | 131.5 | 92 | 89 | Zhou, H., Yang, X., Li, |
| | (1 wt %, 10 mg) | | 2/40/20/38 | | | | L., Liu, X., Huang, Y., |
| | | | (30 mL min⁻¹) | | | | Pan, X., Wang, A., Li, |
| | | | | | | | J., Zhang, T. PdZn |
| | | | | | | | Intermetallic |
| | | | | | | | Nanostructure with |
| | | | | | | | Pd—Zn—Pd Ensembles |
| | | | | | | | for Highly Active and |
| | | | | | | | Chemoselective |
| | | | | | | | Semi-Hydrogenation of |
| | | | | | | | Acetylene. ACS |
| | | | | | | | Catal. 6, 1054-1061 |
| | | | | | | | (2016). |
| 4 | PdIn/MgAl₂O₄ | 90 | C₂H₂/C₂H₄/H₂/He = | 54.9 | 95 | 90 | Feng, Q., Zhao, S., |
| | (2 wt %, 25 mg) | | 0.5/50/5/44.5 | | | | Wang, Y., Dong, J., |
| | | | (120 mL min⁻¹) | | | | Chen, W., He, D., |
| | | | | | | | Wang, D., Yang, J. |
| | | | | | | | Zhu, Y., Zhu, H., Gu, |
| | | | | | | | L., Li, Z., Liu, Y., Yu, |
| | | | | | | | R., Li, J., Li, Y. |
| | | | | | | | Isolated Single-Atom |
| | | | | | | | Pd Sites in |
| | | | | | | | Intermetallic |
| | | | | | | | Nanostructures: High |
| | | | | | | | Catalytic Selectivity for |
| | | | | | | | Semihydrogenation of |
| | | | | | | | Alkynes. J. Am. Chem. |
| | | | | | | | Soc. 139, 7294-7301 |
| | | | | | | | (2017). |
| 5 | Pd—Pt/SiO₂ | 80 | C₂H₂/H₂/He = | 52.0 | 97 | 40 | Ding, K., Cullen D. A., |
| | (1.5 wt %, 20 mg) | | 1.67/3.33/95 | | | | Zhang, L., Cao, Z., |
| | | | (60 mL min⁻¹) | | | | Roy, A. D., Ivanov, I. |
| | | | | | | | N., Cao, D. A General |
| | | | | | | | Synthesis Approach for |
| | | | | | | | Supported Bimetallic |
| | | | | | | | Nanoparticles via |
| | | | | | | | Surface Inorganometallic |
| | | | | | | | Chemistry. Science362, |
| | | | | | | | 560-564 (2018). |
| 6 | Pd1/TiO₂ (SAC) | 120 (dark) | C₂H₂/C₂H₄/H₂/He = | 48.2 | 100 | 65-50 | Guo, Y., Huang, Y., |
| | (0.15 wt %, | 60 (light- | 1/20/10/69 | 12.0 | 25 | 65 | Zeng, B., Han, B., |
| | 15 mg) | 167 mW cm⁻², | (45 mL min⁻¹) | | | | Akri, M., Shi, M., |
| | | UV-Vis) | | | | | Zhao, Y., Li, Q., Su, |
| | | | | | | | Y., Li, L., Jiang, Q., |
| | | | | | | | Cui, Y. T., Li, L., Li, |
| | | | | | | | R., Qiao, B., Zhang, T. |
| | | | | | | | Photo-Thermo |
| | | | | | | | Semi-Hydrogenation of |
| | | | | | | | Acetylene on Pd₁/TiO₂ |
| | | | | | | | Single-Atom Catalyst. |
| | | | | | | | Nat. Commun. 13, 2648 |
| | | | | | | | (2022). |
| 7 | Pd_{1.0}/Bi₂O₃/TiO₂ | 44 | C₂H₂/C₂H₄/H₂/He = | 43.8 | 91 | 90 | Zou, S., Lou, B., Yang, |
| | (Pd 2.3 wt %, | | 1/20/20/59 | | | | K., Yuan, W., Zhu, C., |
| | Bi 4.9 wt %, | | (60 mL min⁻¹) | | | | Zhu, Y., Du, Y., Lu, L., |
| | 30 mg) | | | | | | Liu, J., Huang, W., |
| | | | | | | | Yang, B., Gong, Z., |
| | | | | | | | Cui, Y., Wang, Y., Ma, |
| | | | | | | | L., Ma, J., Jiang, Z., |
| | | | | | | | Xiao, L., Fan, J. |
| | | | | | | | Grafting Nanometer |
| | | | | | | | Metal/Oxide Interface |
| | | | | | | | Towards Enhanced |
| | | | | | | | Low-Temperature |
| | | | | | | | Acetylene Semi- |
| | | | | | | | Hydrogenation. Nat. |
| | | | | | | | Commun. 12, 5770 |
| | | | | | | | (2021). |
| 8 | Pd Single atom/ | 125 | C₂H₂/C₂H₄/H₂/Ar = | 29.7 | 99 | 93 | Zhou, S., Shang, L., |
| | N-graphene | (Photothermal: | 1/20/20/59 | | | | Zhao, Y., Shi, R., |
| | (1.04 wt %, | 5.1 W cm⁻², | (60 mL min⁻¹) | | | | Waterhouse, G. I. N., |
| | 50 mg) | UV-Vis) | | | | | Huang, Y. C., Zheng, |
| | | | | | | | L., Zhang, T. Pd |
| | | | | | | | Single-Atom Catalysts |
| | | | | | | | on Nitrogen-Doped |
| | | | | | | | Graphene for the |
| | | | | | | | Highly Selective |
| | | | | | | | Photothermal |
| | | | | | | | Hydrogenation of |
| | | | | | | | Acetylene to Ethylene. |
| | | | | | | | Adv. Mater. 31, |
| | | | | | | | 1900509 (2019). |
| 9 | Pd/ND@G | 180 | C₂H₂/C₂H₄/H₂/He = | 24.1 | 100 | 90 | Huang, F., Deng, Y., |
| | (0.11 wt %, | | 1/20/10/69 | | | | Chen, Y., Cai, X., |
| | 30 mg) | | (30 mL min⁻¹) | | | | Peng, M., Jia, Z., Ren, |
| | | | | | | | P., Xiao, D., Wen, X., |
| | | | | | | | Wang, N., Liu, H., Ma, |
| | | | | | | | D. Atomically |
| | | | | | | | Dispersed Pd on |
| | | | | | | | Nanodiamond/Graphene |
| | | | | | | | Hybrid for Selective |
| | | | | | | | Hydrogenation of |
| | | | | | | | Acetylene. J. Am. |
| | | | | | | | Chem. Soc. 140, |
| | | | | | | | 13142-13146 (2018). |
| 10 | Pd_{0.006}Cu/SiO₂ | 160 | C₂H₂/C₂H₄/H₂/He = | 22.7 | 100 | 85 | Pei, G. X., Liu, X. Y., |
| | (Pd 0.05 wt %, | | 1/20/20/59 | | | | Yang, X., Zhang, L., |
| | Cu 4.96 wt %, | | (30 mL min⁻¹) | | | | Wang, A., Li, L., |
| | 30 mg) | | | | | | Wang, H., Wang, X., |
| | | | | | | | Zhang, T. Performance |
| | | | | | | | of Cu-Alloyed Pd |
| | | | | | | | Single-Atom Catalyst |
| | | | | | | | for Semihydrogenation |
| | | | | | | | of Acetylene under |
| | | | | | | | Simulated Front-End |
| | | | | | | | Conditions. ACS |
| | | | | | | | Catal. 7, 1491-1500 |
| | | | | | | | (2017). |
| 11 | Al₁₃Fe₄ (20 mg) | 200 | C₂H₂/C₂H₄/H₂/He = | 13.6 | 80 | 85 | Armbrüster, M., |
| | | | 0.5/50/5/44.5 | | | | Kovnir, K., Friedrich, |
| | | | (30 mL min⁻¹) | | | | M., Teschner, D., |
| | | | | | | | Wowsnick, G., Hahne, |
| | | | | | | | M., Gille, P., |
| | | | | | | | Szentmiklósi, L., |
| | | | | | | | Feuerbacher, M., |
| | | | | | | | Heggen, M., Girgsdies, |
| | | | | | | | F., Rosenthal, D., |
| | | | | | | | Schlögl, R. and Grin, Y. |
| | | | | | | | Al₁₃Fe₄ as a Low-Cost |
| | | | | | | | Alternative for |
| | | | | | | | Palladium in |
| | | | | | | | Heterogeneous |
| | | | | | | | Hydrogenation Nat. |
| | | | | | | | Mater. 11, 690-693 |
| | | | | | | | (2012). |
| 12 | PdZn-1.2@ZIF-8C | 120 | C₂H₂/C₂H₄/H₂/Ar = | 9.4 | 85 | 80 | Hu, M. Z., Zhao, S., |
| | (0.7 wt %, | | 0.65/50/5/45 | | | | Liu, S. J., Chen, C., |
| | 50 mg) | | (40 mL min⁻¹) | | | | Chen, W. X., Zhu, W., |
| | | | | | | | Liang, C., Cheong, W.- |
| | | | | | | | C., Wang, Y., Yu, Y., |
| | | | | | | | Peng, Q., Zhou, K. B., |
| | | | | | | | Li, J., Li, Y. D. MOF- |
| | | | | | | | Confined Sub-2 nm |
| | | | | | | | Atomically Ordered |
| | | | | | | | Intermetallic PdZn |
| | | | | | | | Nanoparticles as High- |
| | | | | | | | Performance Catalysts |
| | | | | | | | for Selective |
| | | | | | | | Hydrogenation of |
| | | | | | | | Acetylene. Adv. Mater. |
| | | | | | | | 30, 1801878 (2018). |
| 13 | Na—Ni@CHA | 180 | C₂H₂/H₂/He = | 6.0 | 100 | 90 | Chai, Y., Wu, G., Liu, |
| | (Na 6.3 wt %, | | 1/16/83 | | | | X., Ren, Y., Dai, W., |
| | Ni 3.5 wt %, | | (50 mL min⁻¹) | | | | Wang, C., Xie, Z., |
| | 200 mg) | | | | | | Guan, N., Li, L. |
| | | | | | | | Acetylene-Selective |
| | | | | | | | Hydrogenation |
| | | | | | | | Catalyzed by Cationic |
| | | | | | | | Nickel Confined in |
| | | | | | | | Zeolite. J. Am. Chem. |
| | | | | | | | Soc. 141, 9920-9927 |
| | | | | | | | (2019). |
| 14 | GaPd/Al₂O₃ | 200 | C₂H₂/C₂H₄/H₂/He = | 3.9 | 87 | 85 | Armbrüster, M., |
| | (Pd 0.005 wt %, | | 0.5/50/5/44.5 | | | | Wowsnick, G., |
| | 75 mg) | | (30 mL min⁻¹) | | | | Friedrich, M., Heggen, |
| | | | | | | | M., Cardoso-Gil, R. |
| | | | | | | | Synthesis and Catalytic |
| | | | | | | | Properties of |
| | | | | | | | Nanoparticulate |
| | | | | | | | Intermetallic Ga—Pd |
| | | | | | | | Compounds. J. Am. |
| | | | | | | | Chem. Soc. 133, |
| | | | | | | | 9112-9118 (2011). |
| 15 | Ga₂O₃—Pd/Al₂O₃ | 100 | C₂H₂/C₂H₄/H₂/N₂ = | 1.5 | 20 | 95 | Ding, L., Yi, H., |
| | (0.23 wt %, | | 0.3/33.1/0.6/66 | | | | Zhang, W., You, R., |
| | 50 mg) | | (50 mL min⁻¹) | | | | Cao, T., Yang, J., Lu, |
| | | | | | | | J., Huang, W. |
| | | | | | | | Activating Edge Sites |
| | | | | | | | on Pd Catalysts for |
| | | | | | | | Selective |
| | | | | | | | Hydrogenation of |
| | | | | | | | Acetylene via Selective |
| | | | | | | | Ga₂O₃ Decoration. ACS |
| | | | | | | | Catal. 6, 3700-3707 |
| | | | | | | | (2016). |
| 16 | Ni MoS/Al₂O₃ | 125 | C₂H₂/C₂H₄/H₂/He = | 1.19 | 100 | 90 | Fu, B., McCue, A. J., |
| | (0.5 wt %, | | 0.15/15/3/82 | | | | Liu, Y., Weng, S., |
| | 0.5 g) | | (165 mL min⁻¹) | | | | Song, Y., He, Y., Feng, |
| | | | | | | | J., Li, D. Highly |
| | | | | | | | Selective and Stable |
| | | | | | | | Isolated Non-Noble |
| | | | | | | | Metal Atom Catalysts |
| | | | | | | | for Selective |
| | | | | | | | Hydrogenation of |
| | | | | | | | Acetylene ACS |
| | | | | | | | Catal. 12, 607-615 |
| | | | | | | | (2022). |
| 17 | Single-atom Pd | 120 | C₂H₂/C₂H₄/H₂/He = | 0.2 | 96 | 93 | Wei, S., Li, A., Liu, J. |
| | (0.16 wt %, 1 g) | | 0.5/50/5/44.5 | | | | C., Li, Z., Chen, W., |
| | | | (20 mL min⁻¹) | | | | Gong, Y., Zhang, Q., |
| | | | | | | | Cheon, W. C., Wang, |
| | | | | | | | Y., Zheng, L., Xiao, H., |
| | | | | | | | Chen, C., Wang, D., |
| | | | | | | | Peng, Q., Gu, L., Han, |
| | | | | | | | X., Li, J., Li, Y. Direct |
| | | | | | | | Observation of Noble |
| | | | | | | | Metal Nanoparticles |
| | | | | | | | Transforming to |
| | | | | | | | Thermally Stable |
| | | | | | | | Single Atoms. Nat. |
| | | | | | | | Nanotechnol. 13, |
| | | | | | | | 856-861 (2018). |

It is thus possible for the present invention to provide for a unique hybrid plasmonic catalyst where active RuPt sites were loaded onto ‘black gold’ for photocatalytic semi-hydrogenation of acetylene in excess ethene was demonstrated. This catalyst showed excellent catalytic performance for competitive acetylene semi-hydrogenation in the presence of excess ethene with only visible light illumination and no external heating. With ethene productivity of 320 mmol g⁻¹ h⁻¹, and ˜90% selectivity, DPC/RuPt-10-Calc outperformed all thermal catalysts. Better performance of DPC/RuPt-10-Calc than both of its monometallic counterparts indicated the synergy between Ru and Pt to maintain high productivity and selectivity towards ethene. Surprisingly, this reduction catalyst was stable only when the air was flown together with the reactant feed, and the activity could be maintained for at least 100 h. Supplying air along with the reactant feed prevented the complete in-situ reduction of the metal oxide by simultaneously oxidizing some of the reduced active metal sites, which played a key role in acetylene chemisorption and, in turn, better catalytic performance. This plasmon-mediated simultaneous reduction and oxidation of the active site during the reaction were responsible for the unprecedented stability of the catalyst for at least 100 h.

FDTD simulations showed a five-fold enhancement in the electric field as compared to pristine DPC due to the near-field coupling between the RuPt NPs with DPC. This electric field predominantly concentrated around the RuPt sites within the gaps of Au NPs was crucial in activating chemical bonds of acetylene by inducing polarization in their vicinity. It was observed that contributions from non-thermal effects were significant at lower light intensities, whereas, at higher intensities, the photothermal mode of activation dominated. KIE measured in light was larger than in the dark at all temperatures, implying the contribution from the non-thermal effects along with the photothermal activation of the reactants.

The in-situ DRIFTS studies provided insight into the reaction mechanism over the oxide surface and highlighted the role of the intermediates in determining the selectivity. Hydroxyl groups of a partially oxidized RuPt catalyst surface generated di-σ-bonded acetylene, followed by breaking the triple bond to form two C—O, which then reacted with hydrogen to generate ═C—H bonds. This intermediate formed interacts with the O in a π-bonded fashion and reacts with dissociated hydrogen to yield the final product ethene.

Thus according to a present aspect, a hybrid nanoreactor is provided comprising Pt-doped Ru clusters impregnated over Dendritic Plasmonic Colloidosomes (DPC) of gold, also known as black gold, wherein the DPC is synthesized by depositing Au on Dendritic Fibrous Nano Silica (DFNS) preferably obtained of a cycle by cycle approach, designed for semi-hydrogenation reactions.

According to another aspect a catalytic site composition for the hybrid nanoreactor as plasmonic reduction catalyst is provided comprising of bimetallic nanoparticles with a Ru:Pt ratio of 90:10, wherein the Pt is utilized for H₂ dissociation and Ru for controlling the extent of hydrogenation, enabling selective acetylene semi-hydrogenation reaction.

Preferably a method for synthesizing the claimed hybrid nanoreactor, involves impregnating Pt-doped Ru clusters on DPC of gold, where the DPC is prepared by depositing Au on DENS through a cycle by cycle approach, which said catalyst exhibits exceptional stability of at least 100 hours, even when exposed to air alongside reactants, marking the first instance of air stability in a hydrogenation catalyst, requiring no pre-treatment for hydrogenation.

The application of oxide active sites in said catalyst is immense wherein oxide active sites are continuously generated as air flows with the reactant feed, contributing significantly to the enhanced performance of the catalyst in a hydrogenation process utilizing the catalyst, operating at a Gas Hourly Space Velocity (GHSV) showcasing unparalleled ethene productivity of approximately 320 mmol g⁻¹h⁻¹, with selectivity around 90% in the presence of excess ethene.

It is thus made possible by the present invention to provide for first-of-its-kind hitherto before unknown highly efficient ‘air stabilized’ and ‘plasmonically activated’ semi-hydrogenation of acetylene, for potential use in diverse range of reduction reactions.

1. A hybrid catalytic nanoreactor having selectivity and stability in presence of air for reduction reactions including semi-hydrogenations comprising of: light harvesting dendritic plasmonic colloidosomes (DPC) of gold and co-acting synergistically active catalytic sites of Pt-doped Ru bimetallic nanoparticles for desired significantly special selectivity and air-stability as a plasmonic reduction catalyst favoring plasmon-mediated simultaneous reduction and oxidation of metal active sites for facilitating reduction reactions including semi-hydrogenation activity.

2. The hybrid catalytic nanoreactor as claimed in claim 1, wherein said Pt-doped Ru bimetallic nanoparticles as Pt doped/alloyed Ru nanoparticulate clusters have Ru:Pt ratio of 90:10 impregnated on DPC of gold as black gold having Au deposited Dendritic Fibrous Nano Silica (DFNS) based DPC/RuPt catalyst, wherein said Pt of the bimetallic nanoparticles selective for H₂ dissociation and Ru for controlling the extent of hydrogenation provide for synergistic co-operativity between Ru and Pt to enable selective acetylene semi-hydrogenation reaction with good ethene productivity and selectivity giving acetylene conversion of ˜97% while maintaining ˜90% selectivity.

3. The hybrid catalytic nanoreactor as claimed in claim 1, wherein said nanoreactor is exceptionally air stable for at least 100 hours under continuous flow of air alongside reactant feed towards catalytic reduction based on provided co-existing metal oxide and metal phases under plasmon-mediated simultaneous reduction and oxidation of the active site during reactions with oxide active sites getting continuously generated under air flow with the reactant feed enabling high catalytic reduction activity and said long-term stability for at least 100 h with said catalytic reduction activity dropping by ˜20% of its initial value in 100 h in the absence of airflow that is recoverable by high-temperature air treatment.

4. The hybrid catalytic nanoreactor as claimed in claim 1, wherein said nanoreactor of DPC/RuPt catalyst includes RuPt NPs of ˜1.5 nm deposited on Au nanospheres ˜10 nm with a separation of ˜3 nm shows high catalytic activity based on activating chemical bonds by inducing polarization in their vicinity enabling 5-fold enhancement of electric field as compared to pristine DPC due to near-field coupling between the RuPt nanoparticles with DPC, which electric field is predominantly concentrated around the RuPt sites within the gaps of Au nanoparticles, said nanoreactor with high catalytic activity is also enabled by simultaneous effects of reactor temperature and light intensity to thereby achieve the following:
a. acetylene semi-hydrogenation/reduction with over 85-90% selectivity and productivity of 320 mmol g⁻¹ h⁻¹ of selective ethene outperforming previous all reports by more than double at comparatively lower H₂:C₂H₂ ratio (5:1) and low catalyst bed temperature (Tₛ) of 130° C. and reactor temperature (T_{R}) of 75° C.;
b. highest productivity at a total gas flow of 110 mL min⁻¹ giving moderate acetylene conversion of 20% at high Gas Hourly Space Velocity (GHSV) of 1320000 mL g⁻¹ h⁻¹ entailing said total gas flow of 110 mL min⁻¹, and lower gas flow rate of 9 mL min⁻¹ and higher photo illumination intensity of 3.5 W cm⁻² giving acetylene conversion of ˜97% while maintaining ˜90% selectivity and ethene productivity of 31 mmol g⁻¹ h⁻¹;
c. productivity of ˜300 mmol g⁻¹ h⁻¹ achieved at Tₛ of 200° C. in the dark by external heating, comparable to what was achieved with photo illumination intensity of 3 W cm⁻² (Ts=137° C.) indicating both thermal and non-thermal/photothermal effects thereby unveiling the possibility of lowering the activation energy barrier due to said plasmonic catalysis; and
d. productivity that is comparable at different photo illumination wavelengths owing to the broadband absorption of black gold also at different designated Tₛ values.

5. The hybrid catalytic nanoreactor as claimed in claim 2 wherein said Pt-doped Ru nanoparticulate clusters impregnated on DPC of gold as DPC/RuPt catalyst have ˜1.78 wt. % Ru and 0.29 wt. % Pt with the total metal content being 2.07 wt. %.

6. The hybrid catalytic nanoreactor as claimed in claim 2, wherein said Pt-doped Ru nanoparticulate clusters loaded on DPC of gold as DPC/RuPt catalyst is a calcined Polyvinylpyrrolidone impregnated (PVP)-stabilized RuPt clusters loaded on said DPC in select loadings of 3-20 wt. % that is preferably 10 wt. % RuPt cluster loaded having Brunauer-Emmett-Teller (BET) surface area of ˜415 m² g⁻¹ with a pore volume of 0.45 m³ g⁻¹ vs. as prepared DPC/RuPt catalyst having surface area of 355 m² g⁻¹ with a pore volume of 0.34 cm³ g⁻¹, with said wt. % range of loadings having elemental compositions as per the following:

| Sample | Si (wt %) | O (wt %) | Au (wt %) | Ru (wt %) | Pt (wt %) |
|---|---|---|---|---|---|
| DPC/RuPt-3-Calc | 41.5 ± 7.0 | 16.9 ± 3.0 | 36.8 ± 10.1 | 4.7 ± 1.4 | — |
| DPC/RuPt-5-Calc | 49.1 ± 11.6 | 15.6 ± 3.2 | 29.1 ± 11.9 | 6.0 ± 2.8 | — |
| DPC/RuPt-10-Calc | 59.9 ± 10.6 | 12.5 ± 3.3 | 16.9 ± 7.6 | 10.5 ± 4.1 | 0.2 ± 0.4 |
| DPC/RuPt-20-Calc | 50.1 ± 9.3 | 11.0 ± 2.1 | 19.4 ± 6.6 | 18.3 ± 3.3 | 1.07 0.8. |

7. The hybrid catalytic nanoreactor as claimed in claim 1, of Pt-doped Ru bimetallic nanoparticles as Pt doped/alloyed Ru nanoparticulate clusters impregnated on DPC of gold as black gold having cycle-by-cycle Au deposited onto said Dendritic Fibrous Nano Silica (DFNS) and is preferably 4^{th} cycle Au deposited DPC impregnated with Pt doped/alloyed Ru nanoparticulate clusters.

8. A process for the synthesis of hybrid catalytic nanoreactor as claimed in claim 1, comprising the steps of:
(i) providing said light harvesting dendritic plasmonic colloidosomes (DPC) as black gold including Au deposited onto Dendritic Fibrous Nano Silica (DFNS);
(ii) providing synergistically active catalytic site generating Pt-doped Ru nanoparticles as Ru/Pt nanoparticulate clusters;
(iii) impregnating said Ru/Pt nanoparticulate clusters on said dendritic plasmonic colloidosomes (DPC) of gold and obtaining therefrom said hybrid nanoreactor based DPC/RuPt catalyst including light harvesting dendritic plasmonic colloidosomes (DPC) of gold and co-acting synergistically active catalytic sites.

9. The process as claimed in claim 8, wherein said step of (i) of providing dendritic plasmonic colloidosomes (DPC) as black gold is preferably synthesized based on cycle-by-cycle approach includes the following sub steps:
refluxing (Dendritic Fibrous Nanosilica) DFNS (4 g) with APTES ((3-Aminopropyl)triethoxysilane) (4 mL, 17 mmol) in 250 mL of toluene at 80° C. for 24 h allowing functionalization of DFNS with APTES that was then washed with toluene, ethanol and then dried in an oven for ten hours at 80° C. to yield DFNS-APTS, followed by dispersing said DENS-APTS (500 mg) in water (50 mL) by a sonicator for 15 minutes and stirred for an additional 10 minutes at room temperature to which reaction mixture from a gold-stock solution containing 100 mg mL⁻¹ of gold (III) chloride trihydrate salt, 43 mg was added dropwise;
sonicating the above reaction mixture for 15 minutes, followed by stirring for 2 hours at room temperature and thereafter adding freshly prepared NaBH₄ solution (5 mL, 1 M in water) that was then stirred again for two hours at room temperature followed to which the solid was isolated using centrifugation at 10,000 rpm for 10 minutes, followed by three washings with 30 mL each of water and ethanol with the resultant solid dried at 80° C. in an oven for 2 h and is named DPC-CO, 0th cycle;
dispersing DPC-CO (500 mg) in 1000 mL of prepared K-gold solution by dissolving 300 mg of HAuCl₄·3H₂O and 2800 mg of K₂CO₃ in 2 L of DI water to attain C1 growth cycle whereby the solution was sonicated for 10 seconds and then stirred at room temperature for 10 minutes (200 rpm) followed by the addition of 5 mL of ammonium hydroxide (25%) and subsequent stirring for 15 minutes followed to which Formaldehyde solution (90 mL, 37 wt % in H₂O) was added, and stirred for 24 hours at room temperature providing for solid that was isolated by centrifugation at 10,000 rpm for 10 minutes and washed three times with water (100 mL each time) and ethanol (100 mL each time) to yield DPC-C1 as base material;
repeating the cycle as above with DPC-C1 as base material to obtain DPC-Cx with 2, 3, and 4 growth cycles leading to the resultant solid obtained after 4^{th} cycle of DPC-C4 denoted as “black gold” and used as the plasmonic support over which RuPt nanoparticles (NPs) are loaded.

10. The process as claimed in claim 8, wherein said step (ii) of providing Pt-doped Ru nanoparticles as Ru/Pt nanoparticulate clusters is preferably based on ethylene glycol (EG) reduction process and includes the following sub-steps:
dissolving H₂PtCl₆ and RuCl₃·nH₂O by maintaining Ru:Pt atomic ratio set at 90:10 and PVP (20 equivalence to Ru in monomer units of PVP) in ethylene glocol (EG) (10 mL/mmolpvp) and the reaction mixture stirred at 80° C. under Ar flow for 1 h followed to which the mixture is heated to 180° C. and stirred for 1 hour in an Ar environment when the solution turned dark brown followed by cooling the suspension to room temperature under stirring to which water is added to reduce viscosity with the thus attained colloidal metal clustersdeionized three times by ultrafiltration using a membrane filter with a cut-off molecular weight of 10 kDa before being collected as a powder by lyophilization yielding PVP stabilized Ru/Pt clusters.

11. The process as claimed in claim 8, wherein said step (iii) of impregnating said Ru/Pt nanoparticulate clusters on said dendritic plasmonic colloidosomes (DPC) of gold as DPC/RuPt includes the following sub-steps
dispersing 75 mg of PVP stabilized RuPt bimetallic NPs with effective metal content˜2% in 15 mL ethanol in 250 mL RB flask and sonicating for 90 min followed to which Black Gold (DPC-C4, 15 mg) was then added to this dispersion and again sonicated for 30 s that was thereafter stirred at 60° C. under ambient conditions for 1 h and dried under vacuum at 80° C. for 2 h to yield the resultant powder (DPC/RuPt-10, ASP-as prepared with 10 wt. % loading of RuPt over black gold followed to which the same was calcined in a muffle furnace at 800° C. (10° C./min ramp) for 2 h to oxidize the as-prepared sample to DPC/RuPt-10-Calcined to obtain hybrid nanoreactor based DPC/RuPt catalyst as oxidized PVP free catalyst.

12. A photocatalytic hydrogenation system based on flow reactors for hydrogenation and semi-hydrogenation reactions by the hybrid catalytic nanoreactor as claimed in claim 1 comprising gas inlet (I) and outlet (O) to reactor chamber (RC) including air flow therein,
reactor chamber (RC) with a quartz window (QW) in operative connection for visible light illumination and for supporting porous ceramic including Al₂O₃ crucible accommodating hydrogenation/semi-hydrogenation catalyst, a heater (H) for heating and thermocouples including external and internal-in-built thermocouples to precisely measure catalyst bed (Ts) and reactor (T_{R}) temperatures respectively that are controllable by temperature controllers;
said inlet connected to mass flow controllers (MFCs) including air flow control means with the outlet connected to a gas chromatographic unit having a column and a thermal conductivity detector (TCD).

13. The photocatalytic hydrogenation system as claimed in claim 12, wherein said visible light illumination by light source from the top of reactor chamber (RC) through said quartz window (QW) is focused into the reactor by plurality of lens (L) and mirror (M) based assembly wherein light from said light source including Xe lamp source changes its path perpendicularly to be focused into the reactor through selectively positioned biconvex lenses flanked by said plane mirror (M) for desired focusing.

14. A process for photocatalysis based on the photocatalytic hydrogenation system as claimed in claim 12, comprising the steps of
taking the DPC/RuPtcatalyst (5 mg) in a ceramic porous base crucible and placing inside the reactor chamber,
flowing Argon (Ar) gas (150 mL min⁻¹) through the reactor for 10 minutes,
introducing the reactant gases into the reactor chamber through mass flow controllers; C₂H₂ (10% in Ar) at 30 mL min⁻¹, H₂ at 15 mL min⁻¹, C₂H₄ (60 mL min⁻¹) for competitive reactions and Ar (55 mL min⁻¹) for non-competitive reaction along with air (5 mL min⁻¹) constituting a total flow of 110 mL min⁻¹ (for competitive) and 105 mL min⁻¹ (for non-competitive) at 1 bar pressure, or, introducing into reactor at 1 bar pressure a total flow of 100 mL min⁻¹ of C₂H₂/H₂/Ar=1/5/94 mL min⁻¹;
heating and/or irradiating the catalyst with light (300 W Xenon Lamp ˜2.7 W cm⁻², spanning wave lengths of 400-1100 nm) and monitoring the progress of the reaction inline by calibrated GC connected at the outlet every 4 minutes including
monitoring for thermal and photothermal activation of ingredients towards higher temperature reaction in the dark by providing external heating to the catalyst bed by the heater inside the reaction chamber, monitoring reactions under different irradiated light intensities and wavelength by changing the light intensity of Xe lamp or by changing wavelength of diode lasers keeping the intensity fixed;
wherein calibrating said GC by gases including H₂, O₂, N₂, CO₂, CH₄, C₂H₄, C₂H₆, C₂H₂, and higher hydrocarbons including C₄ is prior done for analysing the outlet gaseous products based on slope of peak area vs. ppm plot giving the calibration constant (area/ppm) used to preferably calculate ethene product formation rate and selectivity of such products formed.

15. A process for photocatalysis as claimed in claim 14, for competitive acetylene semi-hydrogenation by said catalyst carried out in a flow reactor at 1 bar pressure with a total flow of 100 mL min⁻¹ (C₂H₂/H₂/Ar=1/5/94 mL min⁻¹), under illumination of visible light from a Xenon lamp spanning 400-1100 nm at 2.7 W cm⁻²favouring attainment of ethene production rate of 320 mmol g⁻¹ h⁻¹ with a (Gas Hourly Space Velocity) GHSV of 1320000 mL g⁻¹ h⁻¹.
